(19) United States
(12) Patent Application Publication
(10) Pub. No.: US 2023/0216312 A1
(43) Pub. Date: Jul. 6, 2023

(54) SAFETY SYSTEM FOR A MOBILE ROBOT CHARGING STATION

(71) Applicant: OMRON Corporation, Kyoto (JP)

(72) Inventors: Christopher LABORDE, Pleasanton, CA (US); Seth DUNTEN, Pleasanton, CA (US); Andis LANGE, Pleasanton, CA (US); Brian FARR, Pleasanton, CA (US); Thomas KRIZNER, Pleasanton, CA (US)

(21) Appl. No.: 17/997,815

(22) PCT Filed: May 12, 2021
(86) PCT No.: PCT/US2021/032066

§ 371 Date: Nov. 2, 2022

Related U.S. Application Data
(60) Provisional application No. 63/026,660, filed on May 18, 2020.

(51) Int. Cl. H02J 7/00; B25J 5/00; B25J 13/08; G05D 1/02

(52) U.S. Cl. CPC H02J 7/00036; B25J 5/007; B25J 13/087; G05D 1/0225; H02J 7/0044

(57) ABSTRACT

A mobile robot charger can have one or more charger electrical contacts. A shroud can be movable between a closed position and an open position, and can be configured to cover the charger electrical contact(s) in the closed position and to expose the charger electrical contact(s) in the open position. The shroud can be configured to move from the closed position to the open position when the mobile robot engages the charger. A switch, such as a momentary switch, can be movable between an off position and an on position, and can be moved from the off position to the on position when the mobile robot engages the charger. One or more electromagnetic switches (e.g., reed switches) can have an on configuration and an off configuration, and can be turned to the on configuration by one or more magnets on the mobile robot when the mobile robot engages the charger.

### CROSS-REFERENCE TO RELATED APPLICATIONS

This application claims the benefit under 35 U.S.C. § 119(e) of U.S. Provisional Pat. Application No. 63/026,660, filed May 18, 2020, and titled SAFETY SYSTEM FOR A MOBILE ROBOT CHARGING STATION. The entirety contents of each of the above-identified application(s) are hereby incorporated by reference herein and made part of this specification for all that they disclose.

### BACKGROUND

### Field

This disclosure generally relates to mobile robots and charging stations, and in particular to improved safety systems for engaging a charging station with a mobile robot.

### Related Art

Mobile robots are used in many different industries to automate tasks typically performed by humans. Mobile robots can be autonomous or semi-autonomous and designed to operate within a specified area and complete, or assist humans in the completion of, industrial tasks. In one example, a mobile robot is a mobile robotic platform that can be used in a warehouse or other industrial setting to move and arrange materials through interaction with other cart accessories, robotic arms, conveyors and other robotic implementations. Each mobile robot can include its own autonomous navigation system, communication system, and drive components.

### SUMMARY

Disclosed herein are example methods and systems for charging a mobile robot. In one aspect, a method for charging a mobile robot includes advancing a mobile robot towards a charger so that a protrusion of the charger inserts into a recess of the mobile robot. The method includes advancing the mobile robot to move a shroud on the protrusion of the charger from a closed position to an open position to expose one or more electrical contacts on the protrusion. The shroud is biased toward the closed position. The method further includes advancing the mobile robot so that one or more electrical contacts in the recess of the mobile robot come into electrical connection with the one or more electrical contacts on the protrusion of the charger. The method includes advancing the mobile robot so that a magnetic field produced by a magnet on the mobile robot turns on one or more reed switches on the charger. The method further includes advancing the mobile robot to actuate a momentary switch from an off position to an on position to activate the momentary switch, wherein the momentary switch is biased toward the off position. The method includes transmitting electrical signals between the mobile robot and the charger using the electrical connection between the one or more electrical contacts of the mobile robot and the one or more electrical contacts of the charger to perform an electrical handshake.

In response to the one or more reed switches turning on, the activation of the momentary switch, and the electrical handshake being completed, the method includes sending a charging current from the charger, through the electrical connection between the one or more electrical contacts of the charger and the one or more electrical contacts of the mobile robot, and to the mobile robot, for charging the mobile robot.

In another aspect, a charger for charging a mobile robot includes first and second charger electrical contacts each configured to be in electrical connection with corresponding first and second robot electrical contacts when the mobile robot engages the charger. The charger further includes a shroud that is movable between a closed position and an open position. The shroud is configured to cover the first and second charger electrical contacts in the closed position and to expose the first and second charger electrical contacts in the open position. The shroud is configured to be moved from the closed position to the open position when the mobile robot engages the charger. The charger includes a biasing structure for biasing the shroud toward the closed position. The charger further includes a momentary switch that is movable between an off position and an on position. The momentary switch is biased toward the off position and is configured to be moved from the off position to the on position when the mobile robot engages the charger. The charger includes one or more reed switches having an on configuration and an off configuration and are configured to be turned to the on configuration by one or more magnets on the mobile robot when the mobile robot engages the charger.

The charger is configured to enable charging through the first and second charger electrical contacts when both the momentary switch is in the on position, and the one or more reed switches are in the on configuration. The charger is further configured to disable charging through the first and second charger electrical contacts when either the momentary switch is in the off position, or the one or more reed switches are in an off configuration.

The foregoing summary is illustrative only and is not intended to be limiting. Other aspects, features, and advantages of the systems, devices, and methods and/or other subject matter described in this application will become apparent in the teachings set forth below. The summary is provided to introduce a selection of some of the concepts of this disclosure. The summary is not intended to identify key or essential features of any subject matter described herein.

### BRIEF DESCRIPTION OF THE DRAWINGS

Various examples are depicted in the accompanying drawings for illustrative purposes, and should in no way be interpreted as limiting the scope of the examples. Various features of different disclosed examples can be combined to form additional examples, which are part of this disclosure.

FIG. 1 shows an example mobile robot, according to some embodiments.

FIG. 2A shows a side view of the mobile robot of FIG. 1.

FIG. 2B shows a detail of the receiving interface of the mobile robot of FIG. 1.

FIG. 2C shows another detail of the receiving interface of the mobile robot of FIG. 1.

FIG. 3 schematically shows a charging interface that includes a support and a protrusion extending from the support, according to some embodiments.

FIG. 4 shows a top perspective view of an example charging interface according to some embodiments.

FIG. 5A shows the example charging interface of FIG. 4 from a different perspective.

FIG. 5B shows the example charging interface with the shroud in an open position.

FIG. 5C shows the example charging interface engaged with a mobile robot.

FIG. 6 shows the example charging interface of FIG. 4 that is decoupled from the support.

FIG. 7 shows a top perspective detail view of the charging interface of FIG. 4 with the shroud removed.

FIG. 8A shows a bottom perspective view of the charging interface of FIG. 4 with the shroud removed.

FIG. 8B shows an example embodiments of a shroud.

FIG. 8C is a cross-sectional view of an example charging interface.

FIG. 9 shows another bottom perspective view of the charging interface of FIG. 4 with a portion of the protrusion removed to allow a view of a sensor board.

FIG. 10 shows a detail view of an example electromechanical switch, according to some embodiments.

FIG. 11 shows an example sensor board that may be disposed in a charging interface described herein, according to some embodiments.

FIG. 12A shows an example charging interface that includes a trap configuration of a shroud, according to some embodiments.

FIG. 12B shows the example charging interface with the shroud in an open configuration.

FIG. 13A shows an example charging interface with a pivot configuration of a shroud in a closed configuration.

FIG. 13B shows the example charging interface with a pivot configuration of a shroud in an open configuration.

FIG. 14 shows a flowchart representing an example method of charging a mobile robot, according to certain embodiments.

### DETAILED DESCRIPTION

The various features and advantages of the systems, devices, and methods of the technology described herein will become more fully apparent from the following description of the examples illustrated in the figures. These examples are intended to illustrate the principles of this disclosure, and this disclosure should not be limited to merely the illustrated examples. The features of the illustrated examples can be modified, combined, removed, and/or substituted as will be apparent to those of ordinary skill in the art upon consideration of the principles disclosed herein.

The present disclosure relates to improved charging interfaces for mobile robots. In some implementations, mobile or large robot charging takes place using charging contacts (e.g., pads) on the underside of the robot that electrically connect to the chargers that are bolted or otherwise attached to the floor. However, bolted chargers on the floor may not always be available or ideal. In some situation, dust or dirt can cause the charger to become dirty, or to malfunction. Some embodiments disclosed herein can use a charging interface that is with elevated (e.g., above the floor or base of the charger), which can impede dust and dirt from adversely affecting the charger.

Moreover, various problems can existed with robot charging stations, such as electrical arcing, premature electrical flow, and/or power management. For example, when charging, 10 to 100 amps can be going from the charger to the robot at any given time (or other amounts of current, depending on the type of robot). Without safety features, this amount of electricity can severely damage people or objects. For example, without safety features to disable the charging current when no robot is presented for charging, a single piece of steel wool (or other object) make sufficient electrical contact to initiate the charging current, which could lead to fires.

Described herein are safety features that include electromechanical, electromagnetic, electrical, and electrothermal features. Used in isolation and/or in combination, these features can enable the mobile robots to charge while reducing hazards to people and property. For example, electrical contact detection can be performed. In some cases, the charger can verify that a suitable robot is connected before charging is enabled (e.g., an electrical handshake can be used to establish proper electrical contact between a suitable charger and suitable robot). In some cases, the robot can verify that it is connected to a suitable charger before charging is enabled. Additionally or alternatively, stopping the robot from charging before the charging pads completely separate can impede arcing, which is can be dangerous.

Accordingly, improved charging interfaces and methods are described herein. An example charging interface can include first and second charger electrical contacts. The first charger electrical contact may be configured to be in electrical connection with a first robot electrical contact when the mobile robot engages the charger. The second charger electrical contact may be configured to be in electrical connection with a second robot electrical contact when the mobile robot engages the charger. The interface can further include a shroud that is movable between a closed position and an open position. The shroud may be configured to cover the first and second charger electrical contacts in the closed position. For example, the shroud may be biased in the closed position. The shroud may be configured to expose the first and second charger electrical contacts in the open position. When the mobile robot engages the charger, the shroud may be configured to be moved from the closed position to the open position.

The interface can further include a momentary switch, one or more electromagnetic (e.g., magnetic, reed) switches, and/or a temperature sensor. The momentary switch may be movable between an off position and an on position. The momentary switch can be biased toward the off position and be configured to be moved from the off position to the on position when the mobile robot engages the charger. The electromagnetic switches can have an on configuration and an off configuration. The electromagnetic switches can be configured to be turned to the on configuration by one or more magnets on the mobile robot when the mobile robot engages the charger.

In some embodiments, the charging interface can be configured to enable charging through the first and second charger electrical contacts when both the momentary switch is in the on position, and the one or more electromagnetic switches are in the on configuration and to disable charging through the first and second charger electrical contacts when either the momentary switch is in the off position or the one or more electromagnetic switches are in an off configuration. Reference will now be made to the figures.

### Mobile Robots

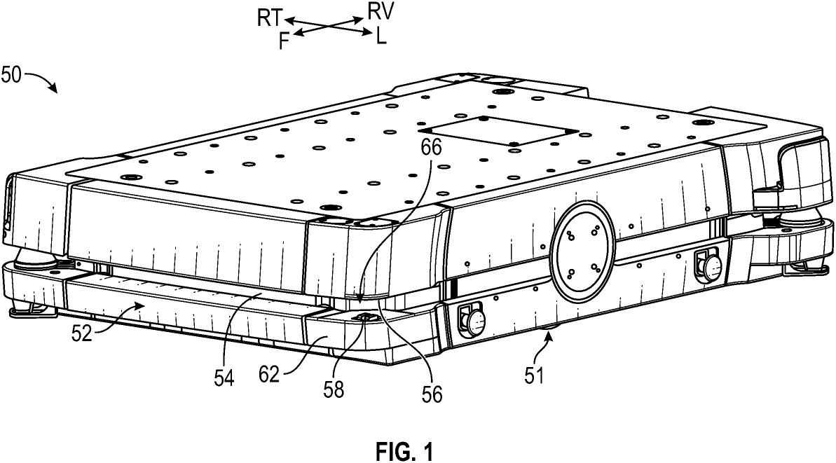

FIG. 1 shows an example mobile robot 50, according to one embodiment. The mobile robot 50 can include one or more wheels 51, a front face 52 that includes a receiving interface 54 for connecting to a charging interface (not shown). The mobile robot 50 can include a first electrical contact 56 and a second electrical contact 58 as well as an actuator 62 for actuating a shroud on the charging interface. The first electrical contact 56 may include a plurality of connectors, and/or the second electrical contact 58 may include a plurality of connectors. The mobile robot 50 can also include one or more magnets 66 near and/or within the receiving interface 54.

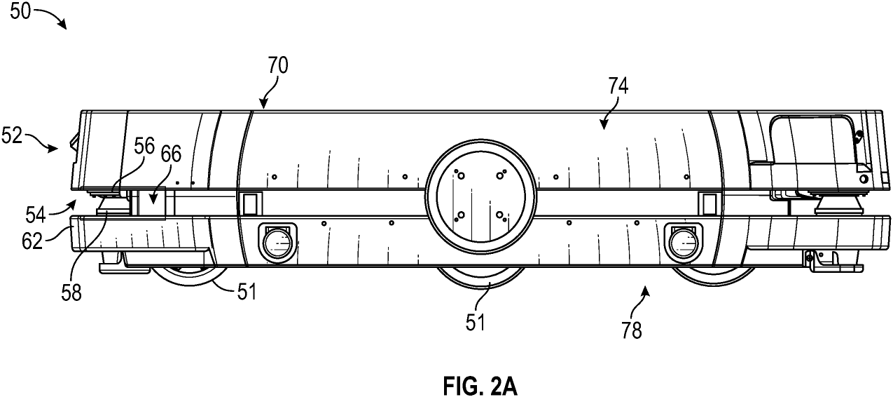

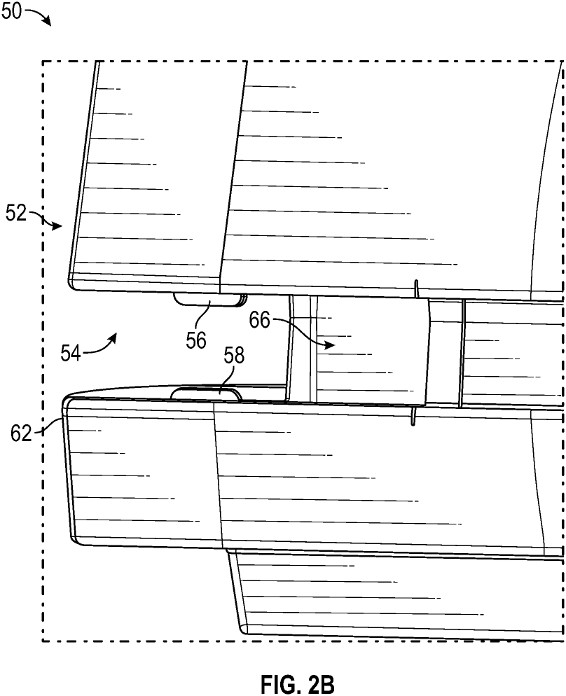

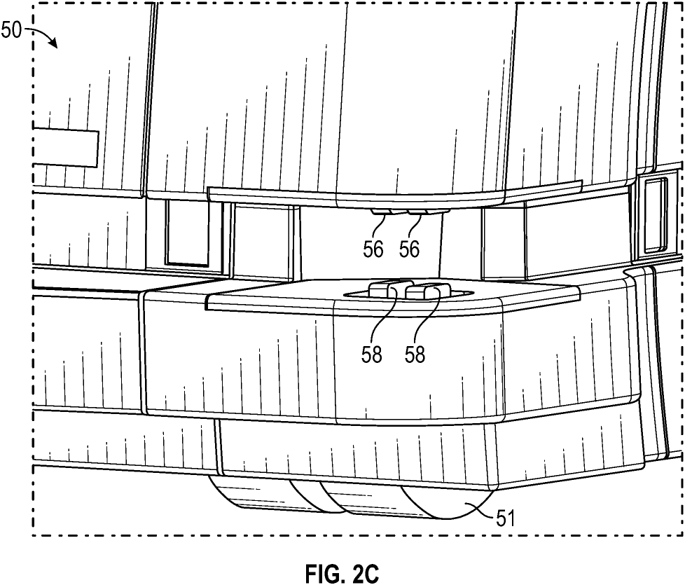

FIG. 2A shows a side view of the mobile robot 50. FIGS. 2B and 2C each show a detailed views of the receiving interface 54. The first electrical contact 56 and second electrical contact 58 can be seen. The mobile robot 50 can include an upper platform 70. The upper platform 70 can be a planer area, although any other suitable shape or structure can be used. The upper platform 70 can include locations for mounting other robotic implements onto the mobile robot 50. For example, the mobile robot 50 can engage with charging interfaces as described herein but additionally or alternatively with movable carts, tables, conveyors, robotic arms, and any other suitable application. The mobile robot 50 can include an outer shell or shielding 74. The outer shielding 74 can include a plurality of sidewalls connected together to enclose or generally enclose navigation systems, communication systems, power systems, and/or other components used for operating the mobile robot 50.

The mobile robot 50 include a receiving interface 54 for connecting to a charging interface, as described herein. The receiving interface 54 can include a recess, such as formed in the front face 52 of the mobile robot 50. The recess can be elevated, such as above the wheels 51, above the axis of one or more of the wheels 51, or above the bottom of the shell or shielding 74. In some cases, the shell or shielding 74 can have a lower portion that is below the recess and an upper portion that is above the recess. The recess can be a generally or substantially horizontal slit in the housing of the mobile robot 50. In some cases, the horizontal slit or other recess can receive a charger interface that can be inserted into the recess for charging the mobile robot 50. The horizontal slit or other recess can also permit light to pass to or from a navigation system of the mobile robot 50, in some embodiments.

The first electrical contact 56 can be positioned on an upper side of the recess. For example, the first electrical contact 56 can be on the upper surface of the recess, and in some cases can extend downward into the recess. The second electrical contact 58 can be positioned on a lower side of the recess. For example, the second electrical contact 58 can be on the lower surface of the recess, and in some cases can extend upward into the recess. The first electrical contact 56 can include one or more conductive teeth. The first electrical contact 56 can be movable, such as in a generally up-and-down direction. The first electrical contact 56 can be biased downward, such as by a spring or other biasing mechanism. The second electrical contact 58 can include one or more conductive teeth. The second electrical contact 58 can be movable, such as in a generally up-and-down direction. The second electrical contact 58 can be biased upward, such as by a spring or other biasing mechanism. When a charging interface is inserted into the recess, the charging interface can move the first electrical contact 56 upward and/or the second electrical contact 58 downward. The first and/or second electrical contacts 56 and/or 58 can be biased against corresponding electrical contacts on the charger during charging.

In some cases the first and second charging contacts 56, 58 of the mobile robot can protect the electrical contacts from debris or unintended contact with other objects. For example, because the electrical contacts are recessed, the shell or shielding 74 of the mobile robot 50 can impede foreign objects from contacting the electrical contacts during charging.

The mobile robot 50 can include an actuator 62 for actuating a shroud on the charging interface, as discussed herein. The actuator 62 can be a portion of the housing or shell or shielding 74 of the mobile robot 50, which can be apart from (e.g., forward of) the electrical contacts 56, 58.

In some cases, the one or more magnets 66 can be positioned inside the mobile robot 50, so that the one or more magnets 66 are not exposed or visible from outside the robot 50. In some cases, the one or more magnets 66 can be positioned on an exterior of the mobile robot 50. The one or more magnets 66 can be positioned in the recess or otherwise on the receiving interface 54 of the mobile robot 50, so that the one or more magnets 66 can trigger the magnetically actuated switches, as discussed herein.

The mobile robot 50 can be autonomous or semi-autonomous. The mobile robot 50 can include a plurality of sensors for sensing the environment. The sensors can include LIDAR and other laser-based sensors and/or range finders for mapping the robot’s surroundings. The mobile robot 50 can include a laser slit including a range finding or LIDAR-type laser contained therein. The mobile robot 50 can include a user interface (not shown) for manually inputting instructions or information and/or receiving information output from the mobile robot 50. In some embodiments, a control panel can additionally or alternatively be located on a side or under a plate or in an unexposed location on the mobile robot 50.

The robot 120 can be generally oriented along a forward-reverse direction F-RV and along a left-right direction L-RT. The forward direction F can be along generally the forward motion of the robot. The reverse direction RV can be opposite the forward direction. The left-right direction L-RT can be orthogonal to the forward-reverse direction F-RV. The left-right direction L-RT and the forward-reverse direction F-RV can be coplanar, for example on a generally horizontal plane.

The upper platform 70, the outer shielding 74, and/or any other components of the mobile robot 50 can be mounted on a chassis. Various different components and structures can be mounted onto the chassis, depending on the purpose and design of the mobile robot 50. A support system 78 can include the one or more support wheels 51 (e.g., 2, 3, 4, or more wheels). The wheels 51 can be coupled with the chassis 140. In some cases, one or more of the wheels 51 can be caster wheels. The wheels 51 can support a load on the chassis against a ground surface. In certain embodiments, the wheels 51 can include individual or combined suspension elements (e.g., springs and/or dampers). Accordingly, in some embodiments, the wheels 51 can move (e.g., up and down) to accommodate uneven terrain, for shock absorption, and for load distribution. In some embodiments, the wheels 51 can be fixed so that they do not move up and down, and the ground clearance height of the mobile robot 50 can be constant regardless of the weight or load of the mobile robot 50. In some examples, one or more of the wheels 51 may be undriven.

The support system can include a drive assembly that can provide acceleration, braking, and/or steering of the mobile robot 50. In some embodiments, the drive assembly drives one or more drive wheels (e.g., two of the wheels 51). These two wheels may be the wheels that guide the motion and directly of the mobile robot 50. For example, if both drive wheels rotate in a first direction, the mobile robot 50 can move forward; if both drive wheels move in a second direction, the robot can move in reverse; if the drive wheels move in opposite directions, or if only one of drive wheels moves, or if the drive wheels move at different speeds, the robot can turn. Braking can be performed by slowing the rotation of the drive wheels, by stopping rotation of the drive wheels, or by reversing direction of the drive wheels. The drive assembly can be coupled (e.g., pivotably coupled) with the chassis. The drive assembly can be configured to engage with the ground surface through a suspension system. The drive assembly can be located at least partially beneath the outer shielding 74 of the mobile robot 50.

Many variations are possible. For example, a single drive assembly can be used, in some cases, which can move the robot forward and/or backward, and steering can be implemented using a separate steering system, such as one or more steering wheels that can turn left or right. In some embodiments, the mobile robot 50 can include 2, 3, or 4 drive assemblies. In certain alternative embodiments, the mobile robot 50 includes only driven wheels and no undriven support wheels. In some embodiments, the one or more drive assemblies can support at least some weight of the robot and/or payload. In some examples, the mobile robot 50 can include two drive wheels and two or four non-driven support wheels.

The mobile robot 50 can include one or more sensors for measuring motion of one or more of the wheels 51, such as the driven wheels. A sensor system may be used to detect and/or calculate rotation, position, direction, and/or other kinematic information from the movement of the wheels 51. In some examples, a plurality of sensors may be used to determine the kinematic information of each wheel. For example, each wheel may be associated with an optical sensor and a magnetic sensor for determining the rotation of the wheel. Use of multiple sensors can be beneficial by providing a redundancy to the kinematic information so that if one system can for some reason not communicate its readings to a controller (e.g., malfunction, environmental shock, etc.), the other (or others) can provide the information. Thus, a system failing may not mean that the controller becomes blind to the kinematic information. A further benefit of multiple sensors may be that the accuracy of the information may be improved because the controller may be able to rely on a greater amount of data in determining what the likely true values are. Examples of optical sensors include encoders (e.g., rotary, linear, absolute, incremental, etc.). Examples of magnetic sensors includes bearing sensors or other speed sensors. The mobile robot 50 can include other types of sensors, such as mechanical sensors, temperature sensors, distance sensors (e.g., rangefinders), and/or other sensors.

### Chargers and Charging Interfaces

Robots, such as the mobile robots 50 described herein, may require charging from time to time. The mobile robot 50 includes an onboard power storage (e.g., one or more batteries), but this power may be depleted through use and/or simply over time. Chargers and charging interfaces can provide a hands-free or automated option for the mobile robot 50 to recharge its power storage.

As noted above, charging a battery of a mobile robot can generally entail transfer of electrical current, which can carry safety risks, such as arcing and fires. Further, charging autonomous or semi-autonomous robots can include challenges related to proper orientation of the robot, proper proximity, and/or proper electrical specifications (e.g., amperage, current). The chargers and interfaces described herein can reduce or solve these challenges.

In some embodiments, the charging interface can be disposed off the ground such that a mobile robot 50 can access it from its side. For example, a charger or docking station can include a base that supports the charging interface. The charging interface can include a protrusion, which can extend generally horizontally from a body of the charger or docking station. The height of the protrusion can correspond to the height of the recess on the mobile robot 50, so that when the mobile robot advances towards the charger or docking station, the protrusion can insert into the recess of the mobile robot 50.

For example, in some embodiments, as the mobile robot 50 drives up to a docking station that houses the charging interface, the mobile robot 50 pushes a shroud back to expose charging electrical contacts (e.g., plates) that were previously hidden underneath the shroud. As the shroud is pushed backwards, corresponding electrical contacts (e.g., sets of spring-loaded copper “teeth”) mounted on the mobile robot 50 slide over and engage the top and bottom charging plates. These conductive teeth on the mobile robot may refer to the first electrical contact 56 and second electrical contact 58 described herein. Within the charging interface may be circuitry (e.g., on a printed circuit board) with an one or more (e.g., an array of) reed switches (e.g., which can be mounted underneath a top copper charging plate). These reed switches may be activated by a magnet (e.g., which can be hidden inside of the mobile robot 50, such as between the electrical contacts 56, 58). As an added layer of safety, there may also be a momentary switch (e.g., a snap-action switch) (e.g., mounted on the underside of the charging interface 100) that may be only activated when the shroud is pushed back far enough for the copper teeth (or other robot electrical contacts 56, 58) to engage the copper charging plates without risk of arcing. Once both the reed switch and the momentary switch are activated, the charger can begin charging the mobile robot 50. Because the required configuration of magnets may be unique, the reed switches or other magnetic switches can provide a high degree of security in ensuring that the mobile robot 50 has properly engaged the charging interface 100. In some cases, the charger and the mobile robot 50 can perform an electronic handshake for verification before charging is enabled. Other alternatives are possible. Now various implementations of chargers and charging interfaces will be described.

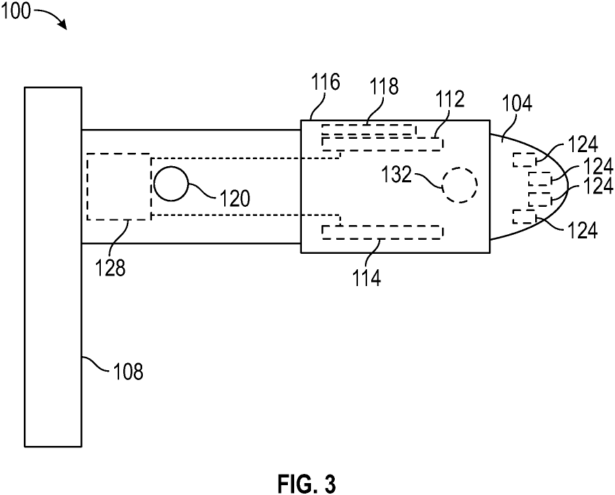

FIG. 3 schematically shows a charger 100 that includes a support 108 and a protrusion 104 extending from the support 108. The charging interface 100 can include a shroud 116 that at least partially covers the protrusion 104. The shroud 116 can cover (partially or completely) or conceal a first electrical contact 112 and a second electrical contact 114. In some cases, the shroud 116 can include at least one brush 118, which can brush across and clean the first electrical contact 112 and/or the second electrical contact 114 as the shroud 116 moves. The charging interface can include a temperature sensor 132. The charging interface 100 can include an electromechanical switch 120 (e.g., a momentary switch) and/or one or more electromagnetic switches 124. A controller 128 may be in electrical communication with the first electrical contact 112 and the second electrical contact 114.

The protrusion 104 can include a housing configured to contain or support one or more elements described herein. The protrusion 104 may be oriented substantially parallel to the ground and/or may be elevated or spaced from the ground or base of the charger 100. The protrusion 104 can extend from the support 108 at approximately a right angle. The support 108 may be coupled (e.g., fixed) to the ground and may be shaped to avoid contact with the mobile robot 50 during charging. The protrusion 104 and/or the support 108 can be partially made of metal, plastic, and/or other rigid material.

The shroud 116 can be one of the safety elements of the charging interface 100. The shroud 116 can be disposed at least partially on and/or around the protrusion 104, such as on or around the housing of the protrusion 104. The shroud 116 can cover or conceal the first electrical contact 112, the second electrical contact 114, the brush 118, the one or more electromagnetic switches 124, and/or the temperature sensor 132. The shroud 116 can be biased away from the support 108 in a closed position. When the shroud 116 is pushed into an open position, it can expose or reveal (e.g., partially or completely) one or more elements that it had been concealing. By forcing the shroud 116 into the open position, the mobile robot 50 can access the first electrical contact 112 and/or the second electrical contact 114 to electrically connect with them using corresponding electrical contacts (e.g., the first electrical contact 56 and/or the second electrical contact 58). The first electrical contact 112 and/or second electrical contact 114 may be disposed outside of the housing of the protrusion 104.

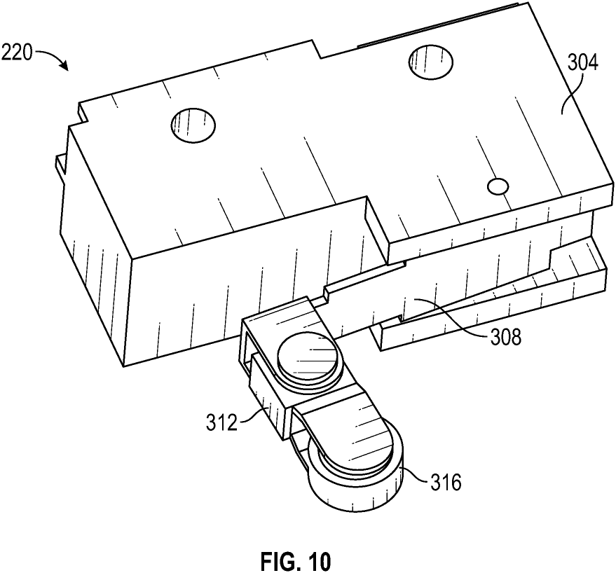

The shroud 116 can be actuated between the open and closed positions in a variety of ways. In some embodiments, the mobile robot 50 cannot access the first electrical contact 112 or the second electrical contact 114 without actuating the shroud 116 into or towards the open position. In some embodiments, the shroud 116 translates laterally (e.g., along the protrusion 104), such as shown in FIG. 3. As the shroud 116 is pushed back, the shroud 116 can engage the electromechanical switch 120. The electromechanical switch 120 can be a momentary switch or some other mechanically driven switch. The electromechanical switch 120 can include a button, a lever arm, a hinge, or some other engagement feature that the shroud 116 directly engages as the shroud 116 is pushed back by the mobile robot 50. The electromechanical switch 120 may be biased in an off position (or a nonconductive position) until the shroud 116 and/or the mobile robot 50 actuate it into an on (or conductive) position. In the on position, the electromechanical switch 120 can partially or fully enable a flow of electricity through the first electrical contact 112 and/or the second electrical contact 114, possibly subject to any other safety requirements being fulfilled. Thus, the electromechanical switch 120 may be activated by the shroud once the mobile robot 50 has advance far enough that charging can be performed without arcing. An example of an electromechanical switch 120 that may be used is shown in FIG. 10.

The shroud and/or electromechanical switch 120 can serve as a safety check to verify that the mobile robot 50 is close enough to the electrical contacts 112, 114, that the mobile robot 50 is properly shaped and/or oriented relative thereto, and/or that the mobile robot 50 is mechanically stable enough to couple to the charging interface 100. If a different mobile robot or other object that is not compatible with the charger 100 approaches the charging interface, but does not have a recess configured appropriately to receive the protrusion, and a structure appropriately positioned relative to the recess to move the shroud 116 towards the open position as the protrusion inserts into the recess, then the shroud would remain in the closed position, which covers the electrical contacts 112, 114 and impedes the object from making electrical connection to the electrical contacts 112, 114. Even if an incompatible object were able to move the shroud 116 partially towards the open position, which could expose at least portions of the electrical contacts 112, 114, the charger 100 can be configured to disable charging until the switch 120 has been activated. Thus, in some cases, an object would not be able to enable charging unless it is appropriately configured (e.g., having a recess with sufficient depth and relative actuating structure) to move the shroud 116 far enough to trigger the switch 120. Also, if the compatible mobile robot 50 were to approach the charger 100, but from an inappropriate angle or orientation, the protrusion 104, shroud 116, and/or momentary switch 120 can impede charging. For example, at the wrong angle, the protrusion 104 would not be able extend far enough into the recess to move the shroud 116 sufficiently to activate the switch 120.

The charger 100 and/or the mobile robot 50 can be configured so that the switch 120 is activated as the mobile robot 50 advances and after the electrical contacts 56 and 58 of the mobile robot 50 have made electrical connection with the electrical contacts 112 and 114 of the charger. Charging can then be enabled without arcing between the electrical contacts. During disengagement of the mobile robot 50 from the charger 100, the mobile robot 50 can retract away from the charger, and the switch 120 turns off while the electrical contacts 56 and 58 of the mobile robot 50 are still electrically connected to the electrical contacts 112 and 114 of the charger 100. This can avoid arcing between the electrical contacts as the mobile robot 50 retracts away from the charger 100.

The electromechanical switch 120 can be actuated by a movement (e.g., translation) of the shroud 116. In some examples, the electromechanical switch 120 can be actuated by the mobile robot 50 directly. For example, in certain implementations the electromechanical switch 120 may be disposed at or near a distal end of the charging interface 100 or of the protrusion 104. In this way, the electromechanical switch 120 may be configured to be directly contacted by an actuator or portion of the mobile robot 50.

When actuated, the electromechanical switch 120 may be depressed into an interior of the protrusion 104 (e.g., further into the housing of the protrusion 104). Alone or in combination with the shroud 116, the electromechanical switch 120 can prevent inadvertent and/or unauthorized release of electrical power into the first electrical contact 112 and/or the second electrical contact 114. Although not shown, electrical communication may exist between the electromechanical switch 120 and the controller 128 and/or with some other controller. The controller 128 can enable and/or increase a flow (e.g., current) of electricity to the first electrical contact 112 and/or second electrical contact 114 in response to detecting that the electromechanical switch 120 is in an on position, possibly subject to any other safety requirements being fulfilled. In some embodiments, the switch 120 can be non-conductive in the off position so that current is impeded from flowing to the electrical contacts 112 and 114. The switch 120 can be conductive in the on position (e.g., when activated by the shroud 116 or mobile robot 50), so that the current can flow through the switch 120 to the electrical contacts 112 and 114, such as for charging the mobile robot 50. Accordingly, in some embodiments, the switch 120 does not communicate with the controller 128, and can directly disable charging in its non-conductive state, for example.

Another safety mechanism for the control of flow of electricity to the first electrical contact 112 and/or the second electrical contact 114 can include a magnetic safety mechanism, such as one or more magnetic and/or electromagnetic switches 124. As shown in FIG. 3, the charging interface 100 can include one or more electromagnetic switches 124. The electromagnetic switches 124 can include reed switches and/or some other electromagnetic switch. The electromagnetic switches 124 can be disposed inside the housing of the protrusion 104, for example. In some embodiments, the electromagnetic switches 124 may be disposed near a distal end of the protrusion 104 (e.g., disposed away from the support 108), as shown in FIG. 3. In some embodiments, such as those described below, the electromagnetic switches 124 may be disposed within the shroud 116 when it is in the closed position. In some embodiments, the one or more electromagnetic switches 124 (e.g., reed switches) can be between the first and second electrical contacts 112 and 114.

Once a sufficient number or configuration of the electromagnetic switches 124 (e.g., half of them, all of them, or at least one of parallel sets) have been turned on, the charger 100 may be configured to enable and/or increase a flow of electrical power to the first electrical contact 112 and/or the second electrical contact 114, possibly subject to any other safety requirements being fulfilled. Although not shown in FIG. 3, the controller 128 may be in electrical communication with the one or more electromagnetic switches 124. Once the controller 128 receives an indication that a sufficient number or configuration of the electromagnetic switches 124 have been turned on, the controller 128 may enable the flow of electricity, subject to any other safety requirements being fulfilled. In some embodiments, the one or more electromagnetic switches 124 can be non-conductive in an off configuration so that current is impeded from flowing to the electrical contacts 112 and 114. The one or more electromagnetic switches 124 can be conductive in an on configuration, so that the current can flow through the one or more electromagnetic switches 124 to the electrical contacts 112 and 114, such as for charging the mobile robot 50. Accordingly, in some embodiments, the one or more electromagnetic switches 124 do not communicate with the controller 128, and can directly disable charging when in the off or non-conductive state, for example.

The electromagnetic switches 124 can be tuned to respond to a magnetic field from one or more magnets in or on the mobile robot 50, such as the one or more magnets 66 described above. The electromagnetic switches 124 may be biased in an off configuration (e.g., outside the presence of a suitable magnetic field). In the presence of a suitable magnetic field, the electromagnetic switches 124 can be configured to be switched to an on configuration.

One or more of the electromagnetic switches 124 may switch to an on and/or off configuration at different times relative to one another. For example, the electromagnetic switches 124 may be disposed spatially one from another such that each may experience the magnetic field at different amounts relative to each other. The electromagnetic switches 124 may be configured in such a way as to require a proper orientation of the mobile robot 50. For example, the charging interface 100 may be configured to prevent the flow of electricity to the first electrical contact 112 and/or the second electrical contact 114 until a threshold number and/or a suitable configuration of electromagnetic switches 124 have been switched on. For example, multiple sets of electromagnetic switches 124 can be coupled in parallel, so that if the electromagnetic switches 124 of any one of the parallel sets are on, then current is able to flow. Each of the multiple parallel sets can include one or more electromagnetic switches 124, which can be coupled in series. In some configurations, a set of electromagnetic switches 124 coupled in series is conductive when all of the electromagnetic switches 124 of the set are on. Thus, in some cases, the arrangement of electromagnetic switches 124 can be in an off (or non-conductive) configuration even if some of the electromagnetic switches 124 are on. For example, if one electromagnetic switch 124 is on, but other electromagnetic switches 124 coupled in series are off, the set can be non-conductive. In some embodiments, the arrangement of electromagnetic switches 124 can be in an on or conductive configuration when all the in-series electromagnetic switches 124 are on (e.g., conductive) for at least one of the parallel sets. In some examples, the electromagnetic switches 124 may be required to be in the on configuration for a threshold amount of time before the flow of electricity is enabled. For example, the controller 128 can implement a timer before enabling charging. The electromagnetic switches 124 (e.g. reed switches) can impede unintended current. For example, if an incompatible object were to move the shroud 116 sufficiently to expose the electrical contacts 112 and 144 and to trigger the switch 120, the charger 100 would not enable charging current unless the one or more electromagnetic switches 124 (e.g., reed switches) are in the on configuration. Thus, if the incompatible object does not have a magnet that is configured to appropriately turn on the electromagnetic switches 124, the charging would remain disabled. Also, the electromagnetic switches 124 can provide safety by ensuring that the mobile robot 50 is close enough and/or properly oriented to prevent or reduce the likelihood of arcing between the mobile robot 50 and the charging interface 100.

The timing of turning on the electromagnetic switches 124 and the electromechanical switch 120 may be such that they are not simultaneous as the mobile robot 50 engages charger 100. Additionally or alternatively, the timing of when the electromagnetic switches 124 and/or the electromechanical switch 120 are turned off may not be simultaneous as the mobile robot 50 disengages from the charger 100. For example, in some examples the relative positions and/or sensitivities of the electromechanical switch 120 and the electromagnetic switches 124 with respect to the respective actuator (e.g., the shroud 116, the actuator 62 of the mobile robot 50) and magnets (e.g., magnets 66 of the mobile robot 50) as the mobile robot 50 advances may be configured such that the electromagnetic switches 124 are turned on before the electromechanical switch 120 is turned on. Additionally or alternatively, they may be configured such that the electromechanical switch 120 is turned off before the electromagnetic switches 124 are turned off, as the mobile robot 50 retracts from the charger 100. This may prevent arcing as the mobile robot 50 decouples from the charging interface 100. Other alternatives are possible (e.g., that the electromechanical switch 120 turns on before the electromagnetic switches 124 do and/or that the electromechanical switch 120 turns off after the electromagnetic switches 124 do).

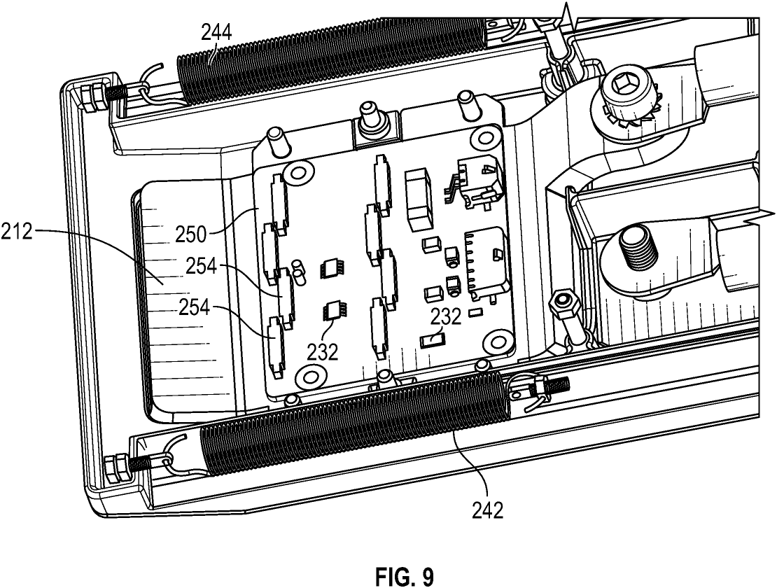

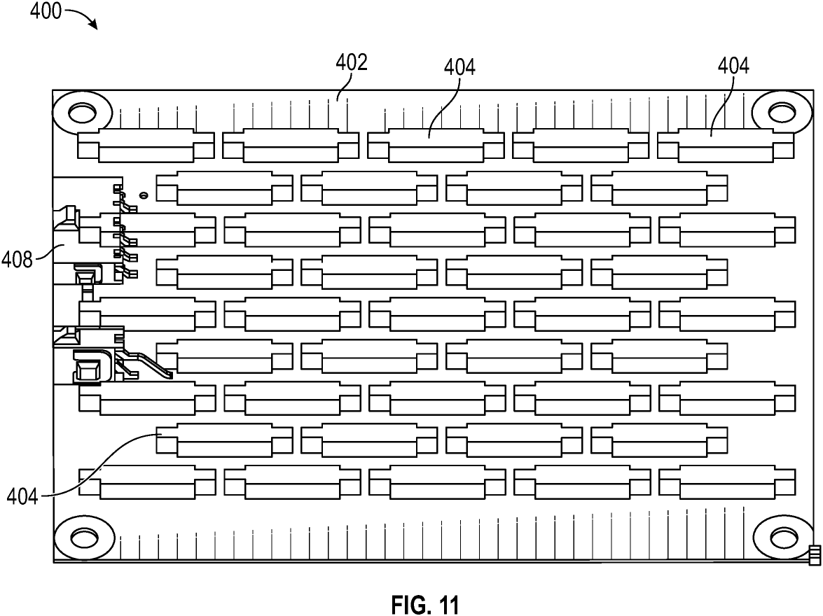

The electromagnetic switches 124 may be in a particular orientation to improve the functionality and/or reliability of the safety mechanism. A plurality of electromagnetic switches 124 may be disposed in parallel with each other. Additionally or alternatively, a plurality of electromagnetic switches 124 may be in series with each other. Electromagnetic switches 124 that are in series may promote an orientation safety check of the mobile robot 50. For example, electromagnetic switches 124 that are in series may not all be switched on unless the mobile robot 50 is properly positioned with respect to each of the electromagnetic switches 124 that are in series with each other. Further, sets of electromagnetic switches 124 that are in parallel may provide a range of acceptable positions for the mobile robot 50. For example, if the mobile robot 50 advances past one set of electromagnetic switches 124 so that they are no longer activated by the magnet, there can be another set of electromagnetic switches 124 positioned further along the motion path to be triggered by the magnet of the mobile robot 50. The parallel sets of electromagnetic switches 124 can provide redundancy so that if one or more of the electromagnetic switches 124 is inoperable, the functionality of the electromagnetic switches 124 is preserved. In some examples, eight electromagnetic switches 124 are arranged such that two sets of electromagnetic switches 124 are arranged in parallel with each other, where each set of electromagnetic switches 124 includes four electromagnetic switches 124 arranged in series, such as shown in FIG. 9. Other configurations are possible (e.g., the configuration shown in FIG. 11).

The charging interface 100 may include one or more cleaning elements that promote the longevity of the electrical components of the charging interface 100 and/or the mobile robot 50. For example, the charging interface 100 may further include a brush 118 configured to clean one or more electrical contacts 112, 114 of the charging interface 100 and/or the mobile robot 50. The brush 118 may be disposed near a distal end of the protrusion 104, which may allow it to come in contact with the target electrical contact(s). As shown, the brush 118 may be disposed at least partially on or over one or both of the first electrical contact 112 and/or the second electrical contact 114 of the charger 100. The brush 118 may be coupled to the shroud 116 so that when the shroud 116 is actuated, the brush 118 brushes along the first electrical contact 112 and/or the second electrical contact 114. The brush 118 may include rigid or flexible bristles comprising metal, plastic, and/or some other suitable material. In FIG. 3 one brush 118 is shown that is configured to clean the first electrical contact 112. Although not shown, the shroud 116 can include a second brush to clean the second electrical contact 114. Alternatively, the brush 118 can be sized and position to clean both the first and second electrical contacts 112 and 114. For example, the brush 118 can wrap around an inside of the shroud 116. The brush 118 may be configured to be removably coupled to the shroud 116, for example so that is can be replaced or removed for cleaning. In some embodiments, at least one brush can be coupled to the protrusion 104 (e.g., to the housing of the protrusion 104), and can be used to clean one or more electrical contacts 56, 58 on the mobile robot 50. The brush(es) can be positioned distally of the charger electrical contact(s) 112, 114 so that the electrical contact(s) 56, 58 of the mobile robot 50 slide across the brush(es) as the mobile robot 50 advances. In some cases, the brush(es) 118 disclosed herein can be movable and biased toward the target contact(s) to ensure improved coupling between the brush 118 and the electrical contacts.

A further safety feature may help ensure that electrical components are functioning properly. If improper connections and/or damaged electrical components are present in one or both of the charging interface 100 and/or the mobile robot 50, significant heat may be generated as a result. Such heat may signal that a problem needs to be addressed before charging at the charging interface 100 can take place or continue. For example, if the one or more of the electrical contacts 112, 114, 56, and/or 58 becomes dirty the transfer of charging current can produce significant amounts of heat, which could damage the charger 100 and/or mobile robot 50 if left unchecked. Accordingly, in some examples, the charging interface 100 includes a temperature sensor 132. The temperature sensor 132 can be in electrical communication with the controller 128 to transmit electrical signals.

The temperature sensor 132 may be configured to detect temperatures that exceed a threshold safety temperature. The temperature sensor 132 can provide measurements indicative of a temperature at the electrical contact 112 and/or the electrical contact 114 of the charger. In some cases, the temperature sensor 132 may be configured to come into thermal communication (e.g., radiative, conductive) with the receiving interface 54 of the mobile robot 50 or some other portion thereof. The temperature sensor 132 may be configured to enable a flow of electricity to the first electrical contact 112 and/or the second electrical contact 114 unless it detects a temperature sensor 132 exceeding the threshold safety temperature. The temperature sensor 132 may be configured to disable the flow of electricity to the first electrical contact 112 and/or second electrical contact 114 if a temperature over a threshold is measured. The temperature can be checked before, during, and/or after charging. For example, as the charging interface 100 is charging a battery of the mobile robot 50, the temperature sensor 132 may detect a temperature over a threshold or a sudden rise in temperature at or near the temperature sensor 132 and may disable power to the first electrical contact 112 and/or second electrical contact 114. In some examples, the temperature sensor 132 additionally or alternatively may send a signal to the mobile robot 50 to open an electrical connection to prevent damage to the mobile robot 50.

The controller 128 can provide a further safety feature of the charging interface 100. The controller 128 of the charger can be configured to verify that the mobile robot 50 is a compatible or approved device before enabling charging. In some embodiments, the mobile robot can verify that the charger is compatible or approved before the mobile robot 50 enables charging. This verification can be preformed by exchanging of information between the mobile robot 50 can the charger 100. For example, digital information can be exchanged, such as a code or password, for verification. In some embodiments, analog signals can be used for verification. Various suitable electrical handshake protocols can be used to enable the charger 100 to verify the mobile robot 50, and/or to enable the mobile robot 50 to verify the charger 100. By way of example, when electrical connection is established between the charger 10 and the mobile robot 50 (e.g., after the shroud has been moved to the open position the mechanical switch 120 has been turned on, and the magnetic switches 124 are in the on configuration), the charger can send a first verification signal to the mobile robot 50. The mobile robot 50 can be configured to recognize the first verification signal (which can serve as verification of the charger 100). The mobile robot 50 can be configured to send a second verification signal to the charger 100 in response to the first verification signal. The charger 100 can be configured to recognize the second verification signal (which can serve as verification of the mobile robot 50), and in response the charger 100 can enable charging. If the charger does not receive the second verification signal back as an answer, it does not enable charging. In some embodiments, the electrical handshake can be at a low voltage and/or low energy, which may make the system safer before implementing high power. Various other suitable handshake or verification protocols can be used. The handshake or other verification protocol can be initiated in response to the activation of the switch 120 (e.g., the momentary switch).

It may be desirable for the mobile robot 50 to verify that the proper current and/or voltage is present at the first electrical contact 112 and/or the second electrical contact 114 before allowing a charging flow of electricity to pass therethrough. As discussed herein, the charger can verify the mobile robot 50 and/or the mobile robot 50 can verify the charger 100. Thus, in some examples the controller 128 may engage in an electrical handshake to ensure that it is safe to enable the flow of electricity through the electrical contacts 112, 114. After the electrical contacts 112, 114 electrically connected to the electrical contacts 56, 58 of the mobile robot 50, but before charging current is enabled (e.g., even after all other safety checks have been passed) the controller 128 may first send a test electrical signal (e.g., a particular current flow, a particular voltage) to the mobile robot 50. In some examples, the mobile robot 50 may provide its own safety verification by sending a test electrical signal to the charging interface 100. If the test is satisfied on the mobile robot 50 side, then the mobile robot 50 may send a clearance signal to the controller 128. Once the controller 128 receives the clearance signal in return, the controller 128 can be configured to enable the flow of charging current to the electrical contacts 112, 114.

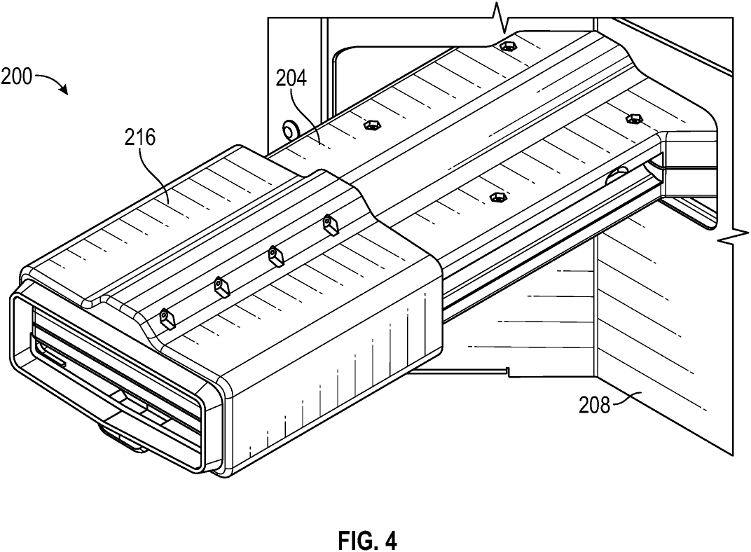

FIG. 4 shows a top perspective view of an example charging interface 200 according to some embodiments. The charging interface 200 shows a protrusion 204 of the charging interface 200 extending from the support 208. The shroud 216 is disposed around the protrusion 204 to allow for translation of the shroud 216 in response to actuation by the mobile robot 50. As shown, the shroud 216 is shaped to fit around the protrusion 204 to reduce the amount of lateral play of the shroud 216 during actuation. The protrusion 204 may be tapered at a distal end to promote better coupling with the receiving interface 54 of the mobile robot 50. For example, the receiving interface 54 on the mobile robot 50 may be flared at the opening to the recess, which can facilitate receipt of the protrusion 204 into the recess.

Note that the charging interface 200 (and any other charging interface described herein) may include one or more features of the charging interface 100, or any other charging interface embodiments described above. Moreover, elements sharing the same name may in certain examples share one or more common features. Thus, unnecessary duplication of description is reduced.

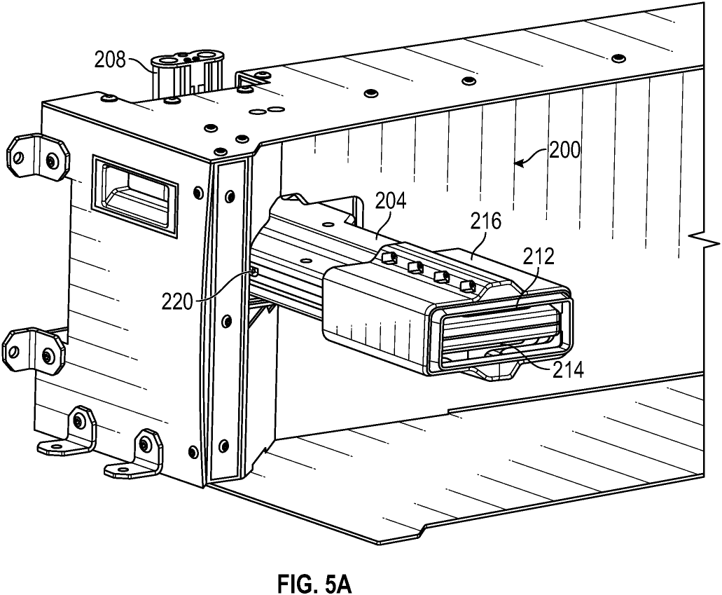

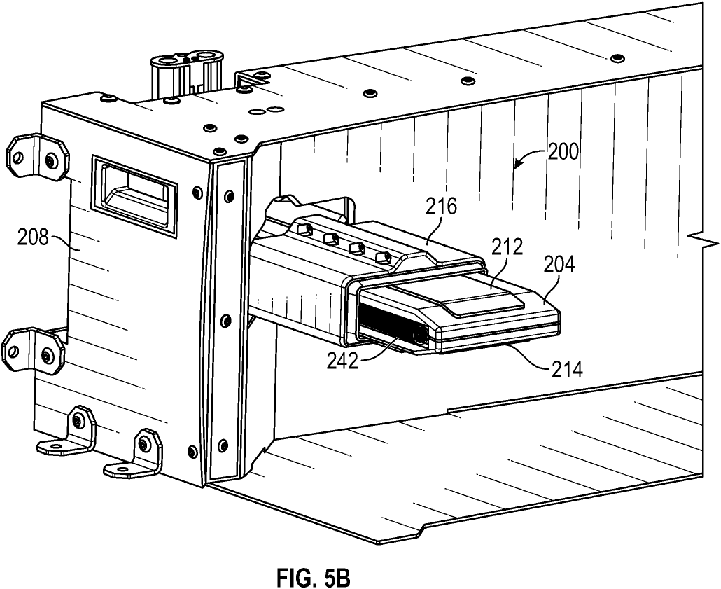

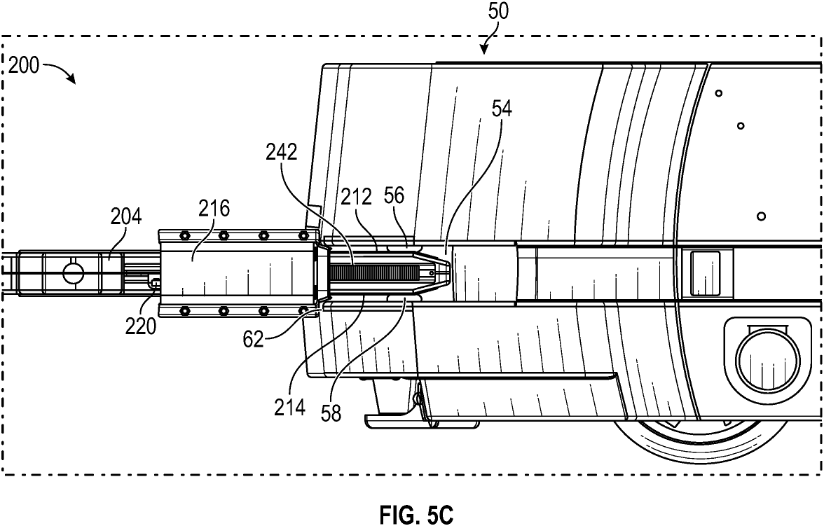

FIG. 5A shows the example charging interface 200 of FIG. 4 from a different perspective, with the shroud in a closed position. FIG. 5B shows the example charging interface 200 with the shroud in the open position. As shown, a first electrical contact 212 and a second electrical contact 214 of the protrusion 204 can be seen. The charging interface 200 further includes an electromechanical switch 220, which can be seen in FIG. 5A. The protrusion 204 is shown being disposed above and parallel to the ground. The first electrical contact 212 is on an upper side of the protrusion 204, and the second electrical contact 214 is on a lower side of the protrusion 204, e.g., facing downward. This configuration can impede an object from unintentionally contacting both electrical contacts 212 and 214. For example, an object that lands on the charging interface 200 may contact the upper electrical contact 212, but would not contact the lower electrical contact 214, thereby failing to make complete connection. This is an additional safety feature, and a benefit of the elevated protrusion 204 for the charging interface 200.

FIG. 5C shows the mobile robot 50 engaged with the charging interface 200. The protrusion 204 extends into a recess on the mobile robot 50. An actuator 62 on the mobile robot 50 pushes the shroud 216 along the protrusion 204 to the open position to thereby expose the first and second electrical contacts 212 and 214 on the charging interface 200. The corresponding electrical contacts 56 and 58 on the mobile robot can make electrical connection with the first and second electrical contacts 212 and 214 of the charging interface 200. Although not shown in FIG. 5C, a magnet in the mobile robot 50 can come into close enough proximity to one or more electromagnetic switches 124 (e.g., reed switches), which can be inside the protrusion 204 so that the one or more electromagnetic switches 124 transition to an on or conductive configuration. When the shroud 216 is moved to the position shown in FIG. 5C, the shroud 216 can push the switch 220 (e.g., a momentary switch). Optionally, the charger and mobile robot 50 can perform and electrical handshake protocol for verification before the charger enables charging.

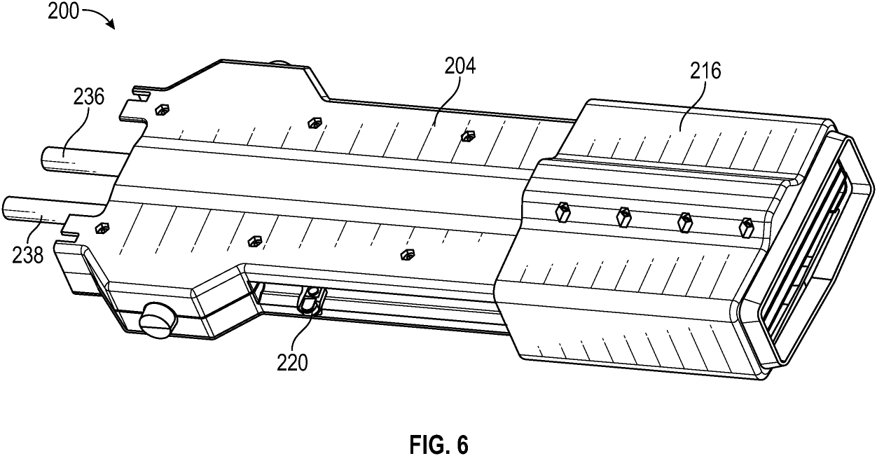

FIG. 6 shows the example charging interface 200 of FIG. 4 decoupled from the support 208. The charging interface 200 includes a first electrical wire 236 and a second electrical wire 238 that are in electrical communication with the first electrical contact 212 and second electrical contact 214 (not visible in FIG. 6), respectively. Charging and signal power can be passed through the electrical wires 236, 238 to the corresponding electrical contacts 212, 214 and to the electrical contacts 56, 58 of the mobile robot 50, provided the required safety checks are satisfied. The wires 236 and/or 238 can be used to transfer data or other signals, such as to a controller 128. For example, signals can be transferred from the first electrical contact 212 and/or the second electrical contact 214 to the controller 128 for performing the electrical handshake, as discussed herein. Data or other signals can be transferred the other direction, such as from the controller to the first electrical contact 212 and/or second electrical contact 214. In some embodiment, the controller can be between the wires 236, 238 and the first electrical contact 212 and second electrical contact 214, such as on the printed circuit board shown in FIG. 9.

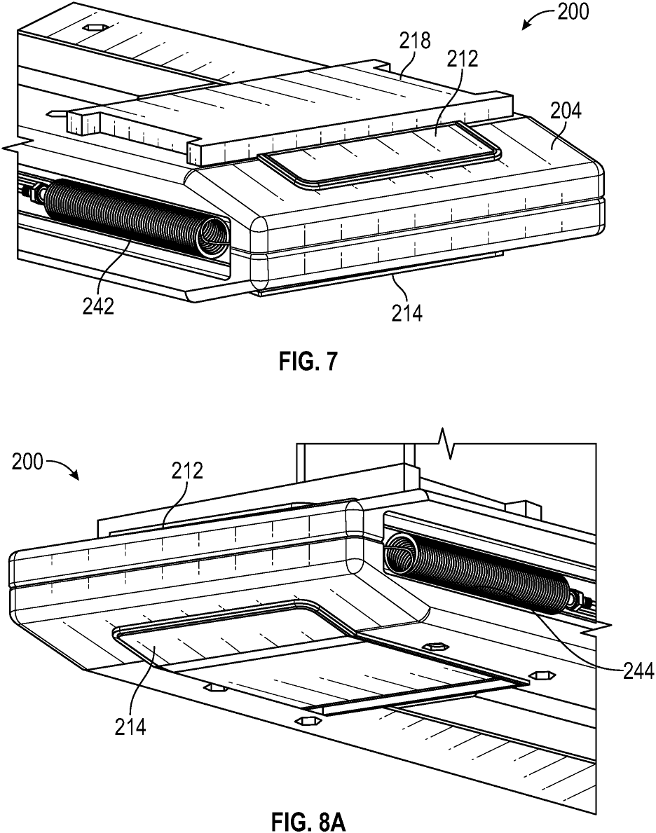

FIG. 7 shows a top perspective detail view of the charging interface 200 of FIG. 4 with the shroud 216 removed. The first electrical contact 212 and the second electrical contact 214 can be seen. A portion of each of the electrical contacts 212, 214 is disposed along a tapered portion of the protrusion 204 near a distal end of the protrusion 204. A brush 218 of the charging interface 200 is shown disposed over the first electrical contact 212 in FIG. 7. In some examples (not shown), a corresponding brush may be disposed below the second electrical contact 214. The brush 218 can be configured to translate with the shroud 216 such that a translation of the brush 218 rubs against the first electrical contact 212 to clean it.

A biasing member 242 (e.g., a spring) is shown disposed along a side of the protrusion 204. The biasing member 242 is coupled to the shroud 216 (not shown) to bias the shroud 216 toward an off or closed position. A corresponding biasing member 244 (not shown in FIG. 7) is disposed on an opposite side of the protrusion 204 and is also coupled to the shroud 216 (not shown in FIG. 7). Any suitable biasing structure can be used to bias the shroud toward the closed position. For example, a single spring can be used. In some cases, a compressible element can be compressed when the shroud 216 moves toward the open position and can rebound to push the shroud 216 back to the closed position.

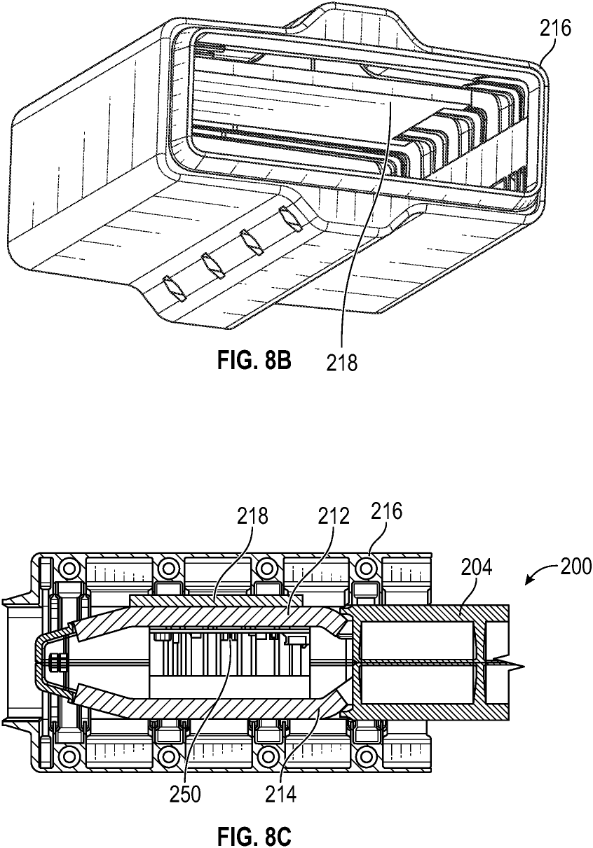

FIG. 8A shows a bottom perspective view of the charging interface 200 of FIG. 4 with the shroud 216 removed. The second electrical contact 214 and the biasing member 244 can be clearly seen. As shown, one or more of the biasing member 242 and/or the biasing member 244 may be disposed within corresponding recesses in the sides of the protrusion 204.

FIG. 8B shows the shroud 216 removed from the protrusion 204. The shroud 216 can include the brush 218. The brush 219 can be coupled to the shroud 216 so that the brush 218 moves with the shroud 216 to clean the first electrical contact 212. The brush 218 can be coupled to a top surface of the inside of the shroud 216. A similar brush can be coupled to a bottom surface of the inside of the shroud 216. The brush(es) can be removably coupled to the shroud, or can be adhered thereto, or any other suitable coupling mechanism or technique can be used.

FIG. 8C is a cross-sectional view of a portion of the charging interface 200. The cross-section of FIG. 8C is taken through a center of the protrusion 204. The charging interface 200 can include circuitry 250, which can be positioned between the first and second electrical contacts 212, 214. The circuitry 250 can be on a printed circuit board (PCB). FIG. 9 shows a bottom perspective view of the charging interface 200 of FIG. 4 with a portion of the protrusion 204 removed to allow a view of an interior of the protrusion 204. The circuitry 250 includes a plurality of electromagnetic switches 254 (e.g., disposed on an underside of the PCB). The electromagnetic switches 254 can be disposed above the second electrical contact 214 (not shown) and/or below the first electrical contact 212. Note that the view of FIG. 9 is from underneath the protrusion 204. As shown, the circuitry 250 includes two sets of electromagnetic switches 254 arranged in parallel. Each set includes four electromagnetic switches 254 and each of the electromagnetic switches 254 within each set is in series with each other. The first set of electromagnetic switches 254 can be closer to the distal end of the protrusion than the second set of electromagnetic switches 254. Thus, if the mobile robot 50 were to advance to a first, its magnet can turn on the first set of electromagnetic switches 254, but not the second set. If the mobile robot 50 were to advance further to a second position, its magnet can turn on the second set of electromagnetic switches 254, but not the first set. Accordingly, the parallel sets of electromagnetic switches 254 can provide a range of positions for the mobile robot 50 where the charging can be enabled. The set of electromagnetic switches 254 arranged in series can be arranged generally laterally to the direction of the protrusion 204. Thus, if the mobile robot 50 were misaligned so that the electrical contacts 56, 58 do not properly align with the charging contacts 212, 214, the magnet of the mobile robot 50 can be positioned to turn on some, but not all of the in-series electromagnetic switches 254. Thus, charging would not be disabled due to misalignment of the mobile robot 50.

The circuitry 250 can include a temperature sensor 232, which can measure the temperature at the circuitry, at the area between the first and second electrical contacts 212, 214, or in the protrusion. The temperature sensor 232 can provide a measurement indicative of temperature at the first electrical contact 212 and/or the second electrical contact 214. The circuitry 250 can include a controller 228. The controller 228 can perform an electrical handshake or other verification protocol, as discussed herein, and can perform various other functions disclosed herein. In some cases, the controller 228 can be located remotely from the electrical contacts, at a location not shown in FIG. 9.

FIG. 10 shows a detailed view of an example electromechanical switch 220, according to some embodiments. The electromechanical switch 220 includes a base 304, a biasing member 308, an arm 312 extending from the biasing member 308, and an engagement feature 316. The base 304 may be coupled (e.g., fixedly, removably) to the protrusion 204. The biasing member 308 may be coupled to the base 304 to allow for actuation of the biasing member 308. The biasing member 308 may be a cantilever spring (e.g., as shown) or some other type of spring. Any suitable biasing structure can be used, such as a spring or compressible elastic material. The arm 312 may extend from the biasing member 308 to allow the engagement feature 316 to have better engagement with a corresponding actuating member (e.g., a portion of the shroud 216, the actuator 62 of the mobile robot 50). The arm 312 may be substantially rigid to maintain an orientation of the engagement feature 316 relative to the biasing member 308. As shown the engagement feature 316 may include a rotating feature to reduce the friction between the engagement feature 316 and the corresponding actuating member. Other electromechanical switches are possible. The switch 220 can be a momentary switch or a biased switch. The switch 220 can be biased to the off or non-conductive position.

FIG. 11 shows example circuitry (e.g., on a printed circuit board) 400 that may be disposed in a charging interface described herein, according to some embodiments. The circuitry 400 can be on a circuit board 402. The circuitry 400 can include a plurality of electromagnetic switches 404. The electromagnetic switches 404 can be arranged in parallel and/or series, as discussed herein. As shown, the circuitry 400 includes 45 electromagnetic switches 404, with 9 sets of electromagnetic switches 404, arranged in parallel. Each set includes 5 electromagnetic switches 404 connected in series with one another. In some embodiments, the electromagnetic switches 404 can be in electrical communication with a communication interface 408. In some examples, the circuitry or another controller can determine whether a sufficient number of the electromagnetic switches 404 have been switched to an on position. If a sufficient number of electromagnetic switches 404 have been switched to the on position, then the a communication interface 408 can send a signal to a controller (e.g., the controller 128 of FIG. 3) to indicate that the safety feature has been satisfied. The flow of electricity can be enabled, subject to the satisfaction of the other required safety features, as discussed herein. Other orientations, arrangements, and numbers of electromagnetic switches 404 are possible.

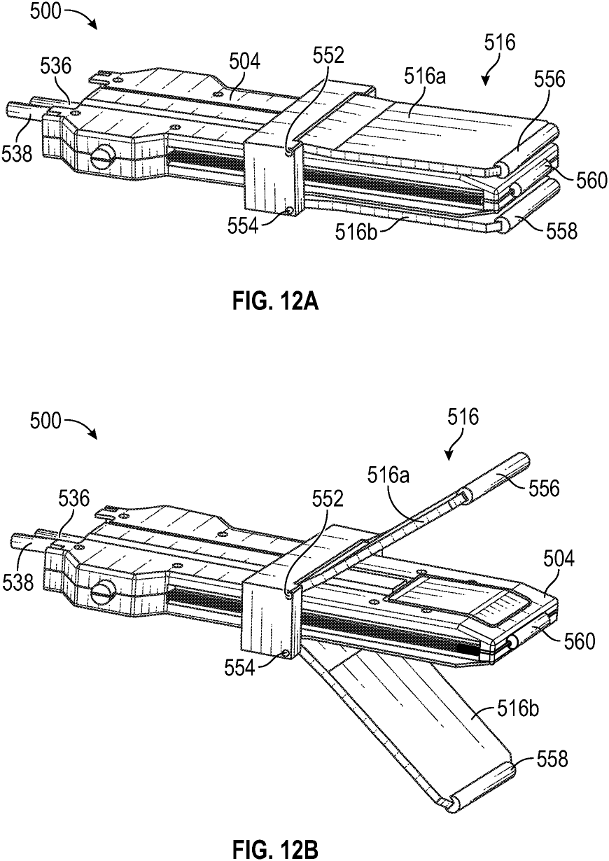

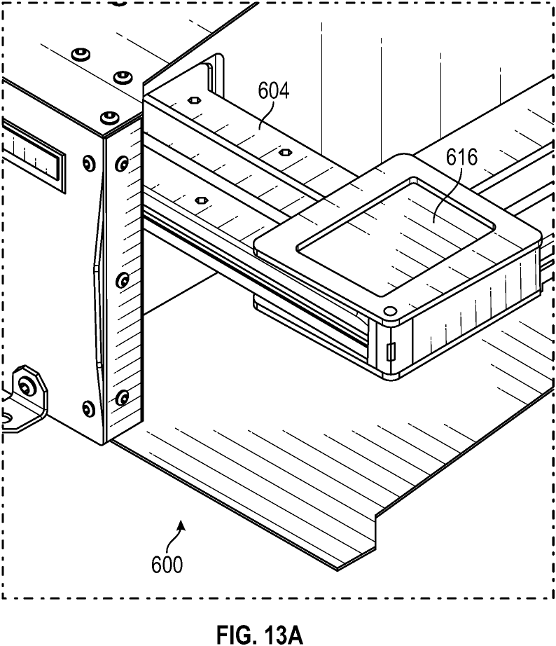

FIG. 12A shows an example charging interface 500 that includes a trap configuration of a shroud 516, according to some embodiments. The charging interface 500 includes a protrusion 504, a shroud 516, and an engagement element 560. The protrusion 504 may be shaped like the protrusion 204 described above.

The shroud 516 can have open and closed configurations mimicking a trap. The shroud 516 can include a first portion or plate 516a and a second portion or plate 516b. The first plate 516a may pivot about a first hinge 552, and the second plate 516b may pivot about a first hinge 554. One or both of the hinges 552, 554 may be oriented substantially horizontally, substantially parallel to the ground, and/or substantially parallel to a top of the protrusion 504. One or both of the hinges 552, 554 may be oriented substantially orthogonally to a direction that the protrusion extends and/or orthogonally to a direction of motion of the mobile robot during engagement with the charging interface 500. As the mobile robot 50 approaches the shroud 516, an actuator of the mobile robot 50 may come into contact with a first bumper 556 and a second bumper 558 coupled to the respective first and second plates 516a, 516b. In response to the contact, the first plate 516a may rotate upward to reveal a first electrical contact thereunder. Similarly, the second plate 516b may rotate downward to reveal a second electrical contact. The open configuration is shown in FIG. 12B. The plates 516a, 516b may be biased in their respective closed positions. First and second electrical wires 536, 538 are shown, which electrically couple to the first and second electrical contacts. In some embodiments, the distal ends of the first plate 516a and/or the second plate 516b can have corresponding rollers 556 and 558, which can roll along the front surface of the mobile robot 50 as the plates 516a, 516b open.

The engagement element 560 may be configured to contact a corresponding element of the mobile robot 50. The engagement element 560 may be configured to contact a distal portion of the receiving interface 54 of the mobile robot 50 and to translate in order to actuate an electromechanical switch (not shown). In some examples, the engagement element 560 is the electromechanical switch and can be actuated directly by the mobile robot 50. For example, a wall or other structure inside the recess that receives the protrusion 504 can be positioned so as to press or otherwise actuate the engagement element 560 (which can be a momentary switch or other switch type). In some embodiments, one of the plates 516a or 516b can push a momentary switch, when they are opened by a sufficient amount.

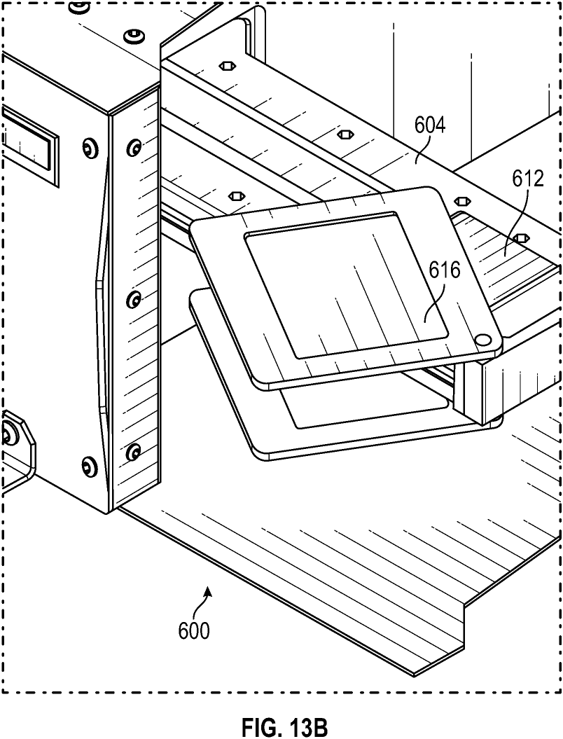

FIG. 13A shows an example charging interface 600 with a pivot configuration of a shroud 616, according to some embodiments. FIG. 13A shows the shroud 616 in a closed position, and FIG. 13B shows the shroud 616 in an open position. The charging interface 600 includes a protrusion 604, a first electrical contact 612, a second electrical contact (not visible in FIG. 13B), and a shroud 616. The shroud 616 can pivot, such as about about an axis that is substantially vertical or substantially perpendicular to the ground. As the mobile robot 50 approaches, the shroud 616 can be pivoted by a structure on the mobile robot 50 to expose the first electrical contact 612 and the second electrical contact (not shown). As shown, each plate of the shroud 616 may be configured to rotate together about the same axis. However, in some examples each plate of the shroud 616 may have its own axis of rotation. Additionally or alternatively, each axis of rotation may be parallel to each other. Other options are possible.

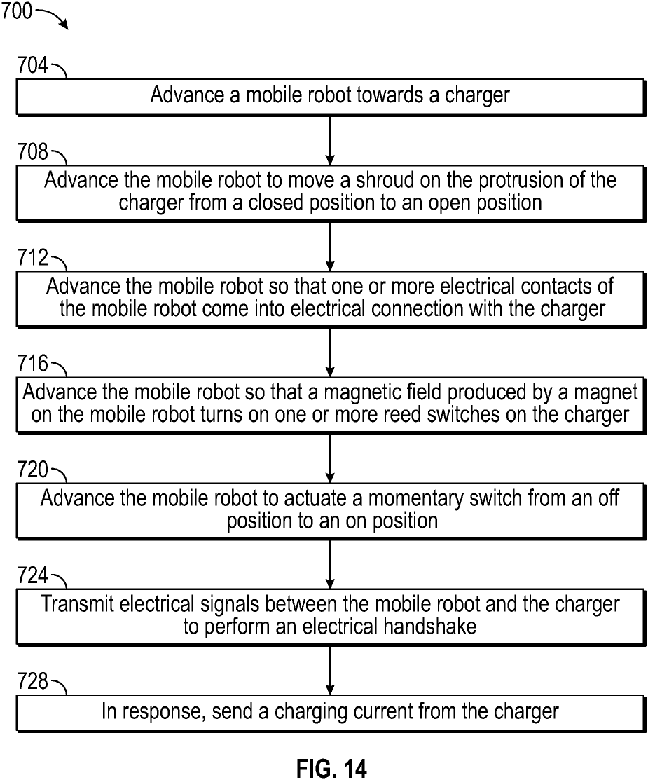

FIG. 14 shows a flowchart representing an example method 700 of charging a mobile robot, according to certain embodiments. The method may be performed by one or more elements described herein. For example, steps of the method may be performed by a charging interface (e.g., the charging interface 100, the charging interface 200, the charging interface 500, the charging interface 600), a mobile robot (e.g., the mobile robot 50), and/or portions of one or both, or any other embodiments disclosed herein.

At block 704, the method 700 includes advancing a mobile robot towards a charger so that a protrusion of the charger inserts into a recess of the mobile robot. At block 708, the method 700 includes advancing the mobile robot to move a shroud on the protrusion of the charger from a closed position to an open position to expose one or more electrical contacts on the protrusion. The shroud may be biased toward the closed position.

Advancing the robot may cause the shroud to actuate the momentary switch from the off position to the on position. In some embodiments, advancing the robot causes a portion of the robot to directly actuate the momentary switch from the off position to the on position. The shroud may slide linearly along the protrusion from the closed position to the open position. In some examples, the shroud pivots between the closed position and the open position. In some examples, the shroud includes an upper portion that pivots upward to expose an upper electrical contact on the protrusion, and a lower portion that pivots downward to expose a lower electrical contact on the protrusion.

At block 712, the method 700 can include advancing the mobile robot so that one or more electrical contacts in the recess of the mobile robot come into electrical connection with the one or more electrical contacts on the protrusion of the charger. The recess on the mobile robot may include a substantially horizontal slit. At block 716, the method 700 includes advancing the mobile robot so that a magnetic field produced by a magnet on the mobile robot turns on one or more reed switches on the charger.

At block 720, the method 700 includes advancing the mobile robot to actuate a momentary switch from an off position to an on position to activate the momentary switch. The momentary switch is biased toward the off position. In some examples, the one or more reed switches turn on before the momentary switch is activated as the mobile robot advances.

At block 724, the method 700 includes transmitting electrical signals between the mobile robot and the charger using the electrical connection between the one or more electrical contacts of the mobile robot and the one or more electrical contacts of the charger to perform an electrical handshake. The electrical handshake may include the charger verifying the mobile robot and/or the mobile robot verifying the charger.

At block 728, the method 700 includes sending a charging current from the charger to the mobile robot. The charging current may be passed through the electrical connection between the one or more electrical contacts of the charger and the one or more electrical contacts of the mobile robot. The block 728 may be performed in response to the one or more reed switches turning on, the activation of the momentary switch, and the electrical handshake being completed. Thus, in some embodiments, each safety measure must be satisfied before charging current is passed from the charger to the mobile robot.

In some examples, the charger includes an upper electrical contact on an upper side of the protrusion and a lower electrical contact on a lower side of the protrusion. The mobile robot can include an upper electrical contact on an upper side of the recess and a lower electrical contact on a lower side of the recess. The protrusion may extend substantially horizontally and/or may be elevated above the ground.

The method 700 may include cleaning the one or more electrical contacts on the protrusion of the charger as the shroud moves. In some examples, the method 700 includes monitoring a temperature at the protrusion of the charger and disabling the charging current when the monitored temperature is above a threshold temperature.

The method 700 may further include retracting the mobile robot from the charger to deactivate the momentary switch and, in response to deactivation of the momentary switch, stopping the charging current to disable charging of the mobile robot. The method 700 can include retracting the mobile robot so that the magnet moves away from the one or more reed switches to turn off the one or more reed switches. Further, the method 700 may include retracting the mobile robot so that the shroud moves from the open position to the closed position to cover the one or more electrical contacts on the protrusion of the charger and retracting the mobile robot so that the protrusion of the charger is withdrawn from the recess of the mobile robot. In some examples, the one or more reed switches turn off after the momentary switch is deactivated as the mobile robot retracts.

The charger can be configured to enable charging when all four safety checks are performed: when the momentary switch 120 is on, when the one or more reed switches 124 are in an on configuration, when the measured temperature is below a threshold, and when an electronic handshake or verification has been completed. The charger can disable charging if the momentary switch 120 is off, or if the one or more reed switches 124 are in an off configuration, or if the measured temperature is above a threshold, or if an electronic handshake or verification has not been completed.

Other combinations are possible. Any combination of the four safety checks can be used. For example, the charger can be configured to enable charging when three safety checks are performed, such as when the momentary switch 120 is on, when the one or more reed switches 124 are in an on configuration, and when an electronic handshake or verification has been completed. In this embodiment, the temperature sensor can be omitted. The charger can disable charging if the momentary switch 120 is off, or if the one or more reed switches 124 are in an off configuration, or if an electronic handshake or verification has not been completed.

The charger can be configured to enable charging when two safety checks are both performed such as when the momentary switch 120 is on and when the one or more reed switches 124 are in an on configuration. The charger can disable charging if the momentary switch 120 is off or if the one or more reed switches 124 are in an off configuration. In some cases, a single safety check can be performed, such as using a momentary switch or one or more reed switches.

Many variations are possible. For example, the one or more reed switches can be omitted in some embodiments. The momentary switch can be omitted in some embodiments. In some embodiments, the switch 120 is not a momentary switch and is not biased to the off position. For example, the structure of the mobile robot 50 can be configured to toggle the switch 120 off as the mobile robot retracts from the charger 100. In some embodiments, a protrusion of the charging interface can include only one electrical contact, rather than two, as shown. In some cases, a second electrical contact can be established elsewhere. In some cases, two protrusions can be used, each with one electrical contact.

### Select Examples

1. A method for charging a mobile robot, the method comprising:
advancing a mobile robot towards a charger so that a protrusion of the charger inserts into a recess of the mobile robot;
advancing the mobile robot to move a shroud on the protrusion of the charger from a closed position to an open position to expose one or more electrical contacts on the protrusion, wherein the shroud is biased toward the closed position;
advancing the mobile robot so that one or more electrical contacts in the recess of the mobile robot come into electrical connection with the one or more electrical contacts on the protrusion of the charger;
advancing the mobile robot so that a magnetic field produced by a magnet on the mobile robot turns on one or more electromagnetic (e.g., reed) switches on the charger;
advancing the mobile robot to actuate a momentary switch from an off position to an on position to activate the momentary switch, wherein the momentary switch is biased toward the off position;
transmitting electrical signals between the mobile robot and the charger using the electrical connection between the one or more electrical contacts of the mobile robot and the one or more electrical contacts of the charger to perform an electrical handshake; and
in response to the one or more electromagnetic (e.g., reed) switches turning on, the activation of the momentary switch, and the electrical handshake being completed, sending a charging current from the charger, through the electrical connection between the one or more electrical contacts of the charger and the one or more electrical contacts of the mobile robot, and to the mobile robot, for charging the mobile robot.

2. The method of Example 1, wherein advancing the robot moves the shroud so that the shroud actuates the momentary switch from the off position to the on position.

3. The method of any one of Examples 1 to 2, wherein advancing the robot causes a portion of the robot to actuate the momentary switch from the off position to the on position.

4. The method of any one of Examples 1 to 3, wherein the shroud slides linearly along the protrusion from the closed position to the open position.

5. The method of any one of Examples 1 to 3, wherein the shroud pivots between the closed position and the open position.

6. The method of any one of Examples 1 to 3, wherein the shroud includes an upper portion that pivots upward to expose an upper electrical contact on the protrusion, and a lower portion that pivots downward to expose a lower electrical contact on the protrusion.

7. The method of any one of Examples 1 to 6, wherein the charger includes an upper electrical contact on an upper side of the protrusion and a lower electrical contact on a lower side of the protrusion, and wherein the mobile robot includes an upper electrical contact on an upper side of the recess and a lower electrical contact on a lower side of the recess.

8. The method of any one of Examples 1 to 7, wherein the protrusion extends substantially horizontally and is elevated above the ground.

9. The method of any one of Examples 1 to 8, wherein the recess on the mobile robot comprises a substantially horizontal slit.

10. The method of any one of Examples 1 to 9, comprising cleaning the one or more electrical contacts on the protrusion of the charger as the shroud moves.

11. The method of any one of Examples 1 to 10, wherein the one or more electromagnetic (e.g., reed) switches turn on before the momentary switch is activated as the mobile robot advances.

12. The method of any one of Examples 1 to 11, comprising:
monitoring a temperature at the protrusion of the charger; and
disabling the charging current when the monitored temperature is above a threshold temperature.

13. The method of any one of Examples 1 to 12, wherein transmitting electrical signals to perform the electrical handshake comprises:
the charger verifying the mobile robot; and
the mobile robot verifying the charger.

14. The method of any one of Examples 1 to 13, further comprising:
retracting the mobile robot from the charger to deactivate the momentary switch;
in response to deactivation of the momentary switch, stopping the charging current to disable charging of the mobile robot;
retracting the mobile robot so that the magnet moves away from the one or more electromagnetic (e.g., reed) switches to turn off the one or more electromagnetic (e.g., reed) switches;
retracting the mobile robot so that the shroud moves from the open position to the closed position to cover the one or more electrical contacts on the protrusion of the charger; and
retracting the mobile robot so that the protrusion of the charger is withdrawn from the recess of the mobile robot.

15. The method of Example 14, wherein the one or more electromagnetic (e.g., reed) switches turn off after the momentary switch is deactivated as the mobile robot retracts.

16. A charger for charging a mobile robot, the charger comprising:
a first charger electrical contact that is configured to be in electrical connection with a first robot electrical contact when the mobile robot engages the charger;
a second charger electrical contact that is configured to be in electrical connection with a second robot electrical contact when the mobile robot engages the charger;
a shroud that is movable between a closed position and an open position, wherein the shroud is configured to cover the first and second charger electrical contacts in the closed position, wherein the shroud is configured to expose the first and second charger electrical contacts in the open position, and wherein the shroud is configured to be moved from the closed position to the open position when the mobile robot engages the charger;
a biasing structure for biasing the shroud toward the closed position;
a momentary switch movable between an off position and an on position, wherein the momentary switch is biased toward the off position, and wherein the momentary switch is configured to be moved from the off position to the on position when the mobile robot engages the charger;
one or more electromagnetic (e.g., reed) switches having an on configuration and an off configuration, wherein the one or more electromagnetic (e.g., reed) switches are configured to be turned to the on configuration by one or more magnets on the mobile robot when the mobile robot engages the charger;
wherein the charger is configured to:
   enable charging through the first and second charger electrical contacts when both the momentary switch is in the on position, and the one or more electromagnetic (e.g., reed) switches are in the on configuration; and
   disable charging through the first and second charger electrical contacts when either the momentary switch is in the off position, or the one or more electromagnetic (e.g., reed) switches are in an off configuration.

17. The charger of Example 16, comprising a controller configured to perform a handshake procedure to verify the mobile robot before charging is enabled.

18. The charger of any one of Examples 16 to 17, comprising a controller configured to receive a signal from the mobile robot, and to enable charging in response to the signal received from the mobile robot.

19. The charger of any one of Examples 16 to 18, comprising a temperature sensor configured to measure a temperature of the charger, wherein the charger is configured to disable charging if the measured temperature of the charger is above a threshold.

20. The charger of any one of Examples 16 to 19, comprising an elevated protrusion that extends generally horizontally, wherein the first charger electrical contact is on an upper side of the protrusion, and wherein the second charger electrical contact is on a lower side of the protrusion.

21. The charger of any one of Examples 16 to 20, wherein the shroud is configured to move the momentary switch to the on position.

22. The charger of any one of Examples 16 to 21, wherein the momentary switch is positioned so that the mobile robot contacts the momentary switch to move the momentary switch to the on position.

23. The charger of any one of Examples 16 to 22, wherein the shroud is configured to slide between the closed position and the open position.

24. The charger of any one of Examples 16 to 22, wherein the shroud is configured to pivot between the closed position and the open position.

25. The charger of any one of Examples 16 to 22, wherein the shroud comprises:
an upper portion that pivots upward to expose the first charger electrical contact on an upper side of a protrusion; and
a lower portion that pivots downward to expose the second charger electrical contact on a lower side of the protrusion.

26. The charger of any one of Examples 16 to 25, wherein the shroud comprises a brush that is configured to brush one or both of the first and second charger electrical contacts as the shroud moves.

27. The charger of any one of Examples 16 to 26, wherein the one or more electromagnetic (e.g., reed) switches comprise:
a first set of multiple electromagnetic (e.g., reed) switches arranged in series; and
a second set of multiple electromagnetic (e.g., reed) switches arranged in series, wherein the first and second sets of multiple electromagnetic (e.g., reed) switches are arranged in parallel.

28. The charger of Example 27, wherein the first set of multiple electromagnetic (e.g., reed) switches is positioned to be closer to the mobile robot than the second set of multiple electromagnetic (e.g., reed) switches.

29. A charging interface comprising:
one or more electrical contacts; and
a shroud that is movable between a closed position and an open position, wherein the shroud is configured to cover the one or more electrical contacts in the closed position, wherein the shroud is configured to expose the one or more electrical contacts in the open position.

30. The charging interface of Example 29, wherein the shroud is biased toward the closed position.

31. The charging interface of any one of Examples 29 to 30, wherein the shroud is configured to slide between the closed position and the open position.

32. The charging interface of any one of Examples 29 to 30, wherein the shroud is configured to pivot between the closed position and the open position.

33. The charging interface of any one of Examples 29 to 30, wherein the shroud comprises:
an first portion that pivots in a first direction to expose a first of the one or more electrical contacts; and
a second portion that pivots in a second direction to expose a second one of the one or more electrical contacts.

34. The charging interface of any one of Examples 29 to 33, wherein the shroud comprises a brush that is configured to brush the one or more electrical contacts as the shroud moves.

35. The charging interface of any one of Examples 29 to 34, comprising a switch that is movable between an off position and an on position.

36. The charging interface of Example 35, wherein the switch is a momentary switch that is biased toward the off position.

37. The charging interface of any one of Examples 35 to 36, wherein the shroud is configured to move the switch to the on position.

38. The charging interface of any one of Examples 35 to 37, configured to disable charging when the switch is in the off position.

39. The charging interface of any one of Examples 29 to 38, comprising one or more electromagnetic (e.g., reed) switches.

40. The charging interface of Example 39, wherein the one or more electromagnetic (e.g., reed) switches are configured to turn on in response to a magnetic field above a closing threshold and to turn off in response to a magnetic field below an opening threshold.

41. The charging interface of any one of Examples 39 to 40, wherein the one or more electromagnetic (e.g., reed) switches comprise:
a first set of multiple electromagnetic (e.g., reed) switches arranged in series; and
a second set of multiple electromagnetic (e.g., reed) switches arranged in series, wherein the first and second sets of multiple electromagnetic (e.g., reed) switches are arranged in parallel.

42. The charging interface of any one of Examples 39 to 41, configured to disable charging when the one or more electromagnetic (e.g., reed) switches are in an off configuration.

43. The charging interface of any one of Examples 29 to 42, comprising a temperature sensor configured to measure a temperature of the charging interface.

44. The charging interface of Example 43, configured to disable charging when the measured temperature of the charging interface is above a threshold.

45. The charging interface of any one of Examples 29 to 44, wherein one or more electrical contacts comprise:
a first electrical contact on a first side of the charging interface; and
a second electrical contact on a second side of the charging interface.

46. The charging interface of any one of Examples 29 to 45, configured to perform a handshake procedure before charging is enabled.

47. The charging interface of any one of Examples 29 to 46, comprising a controller configured to receive a signal from a charge-receiving device, and to enable charging in response to the signal received from the charge-receiving device.

48. The charging interface of any one of Examples 29 to 47, comprising an elevated protrusion that extends generally horizontally, wherein the one or more electrical contacts are on the protrusion.

49. A charger for charging a mobile robot, the charger including the charging interface of any one of Examples 29 to 48.

50. A charging interface for charging a mobile robot, the interface comprising:
one or more (e.g., first and second) electrical contacts;
a shroud biased toward a closed position, the shroud configured to expose the first and second electrical contact in an open position and to at least partially cover the one or more electrical contacts in the closed position;
a momentary switch actuatable by the shroud or the mobile robot, the momentary switch biased toward an off position and configured to impede a flow of electricity through the charging interface while in the off position; and
one or more electromagnetic (e.g., reed) switches configured to magnetically engage with one or more magnets associated with the mobile robot, wherein the one or more electromagnetic (e.g., reed) switches have a default off configuration to impede the flow of electricity through the charging interface, and wherein the one or more electromagnetic (e.g., reed) switches are configured to switch to an on configuration in response to magnetic engagement with the one or more magnets.

51. The charging interface of Example 50, comprising a controller configured to detect an electrical signal from the mobile robot, wherein, in response to detection of the electrical signal, the controller is configured to enable the flow of electricity through the charging interface for charging the mobile robot.

52. The charging interface of any one of Examples 50 to 51, comprising a temperature sensor configured to make a determination that a temperature of a portion of the charging interface is above a threshold temperature and, based on the determination, impede the flow of electricity through the charging interface.

53. A mobile robot comprising:
one or more robot electrical contacts configured to be in electrical contact with one or more corresponding charger electrical contacts of a charger when the mobile robot engages the charger;
an actuator for moving a shroud that covers the one or more charger electrical contacts as the mobile robot engages the charger; and
a magnet positioned to activate one or more electromagnetic (e.g., reed) switches on the charger as the mobile robot engages the charger.

54. The mobile robot of Example 53, comprising a controller configured to perform a handshake procedure with the charger before charging is enabled.

55. The mobile robot of any one of Examples 53 to 54, comprising a controller configured to receive an electrical signal to verify the charger before charging is enabled.

56. The mobile robot of any one of Examples 53 to 55, comprising a recess configured to receive a protrusion of the charger.

57. The mobile robot of Example 56, wherein the recess comprises a generally horizontal elevated slit.

58. The mobile robot of any one of Examples 56 to 57, wherein the one or more robot electrical contacts includes an upper robot electrical contact on an upper side of the recess, and a lower robot electrical contact on a lower side of the recess.

### Additional Considerations

Terms of orientation used herein, such as “top,” “bottom,” “proximal,” “distal,” “longitudinal,” “lateral,” and “end,” are used in the context of the illustrated example. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular,” “cylindrical,” “semi-circular,” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain examples include or do not include, certain features, elements, and/or steps. Thus, such conditional language is not generally intended to imply that features, elements, and/or steps are in any way required for one or more examples.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

The terms “approximately,” “about,” and “substantially” as used herein represent an amount close to the stated amount that still performs a desired function or achieves a desired result. For example, in some examples, as the context may dictate, the terms “approximately,” “about,” and “substantially,” may refer to an amount that is within less than or equal to 10% of the stated amount. The term “generally” as used herein represents a value, amount, or characteristic that predominantly includes or tends toward a particular value, amount, or characteristic. As an example, in certain examples, as the context may dictate, the term “generally parallel” can refer to something that departs from exactly parallel by less than or equal to 20 degrees. All ranges are inclusive of endpoints.

Several illustrative examples of mobile robots and charging interfaces have been disclosed. Although this disclosure has been described in terms of certain illustrative examples and uses, other examples and other uses, including examples and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various examples. All possible combinations and subcombinations of elements and components described herein are intended to be included in this disclosure. No single feature or group of features is necessary or indispensable.

Certain features that are described in this disclosure in the context of separate implementations can also be implemented in combination in a single implementation. Conversely, various features that are described in the context of a single implementation also can be implemented in multiple implementations separately or in any suitable subcombination. Moreover, although features may be described above as acting in certain combinations, one or more features from a claimed combination can in some cases be excised from the combination, and the combination may be claimed as a subcombination or variation of a subcombination.

Any portion of any of the steps, processes, structures, and/or devices disclosed or illustrated in one example in this disclosure can be combined or used with (or instead of) any other portion of any of the steps, processes, structures, and/or devices disclosed or illustrated in a different example or flowchart. The examples described herein are not intended to be discrete and separate from each other. Combinations, variations, and some implementations of the disclosed features are within the scope of this disclosure.

While operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Additionally, the operations may be rearranged or reordered in some implementations. Also, the separation of various components in the implementations described above should not be understood as requiring such separation in all implementations, and it should be understood that the described components and systems can generally be integrated together in a single product or packaged into multiple products. Additionally, some implementations are within the scope of this disclosure.

Further, while illustrative examples have been described, any examples having equivalent elements, modifications, omissions, and/or combinations are also within the scope of this disclosure. Moreover, although certain aspects, advantages, and novel features are described herein, not necessarily all such advantages may be achieved in accordance with any particular example. For example, some examples within the scope of this disclosure achieve one advantage, or a group of advantages, as taught herein without necessarily achieving other advantages taught or suggested herein. Further, some examples may achieve different advantages than those taught or suggested herein.

Some examples have been described in connection with the accompanying drawings. The figures are drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various examples can be used in all other examples set forth herein. Additionally, any methods described herein may be practiced using any device suitable for performing the recited steps.

For purposes of summarizing the disclosure, certain aspects, advantages and features of the inventions have been described herein. Not all, or any such advantages are necessarily achieved in accordance with any particular example of the inventions disclosed herein. No aspects of this disclosure are essential or indispensable. In many examples, the devices, systems, and methods may be configured differently than illustrated in the figures or description herein. For example, various functionalities provided by the illustrated modules can be combined, rearranged, added, or deleted. In some implementations, additional or different processors or modules may perform some or all of the functionalities described with reference to the examples described and illustrated in the figures. Many implementation variations are possible. Any of the features, structures, steps, or processes disclosed in this specification can be included in any example.

In summary, various examples of mobile robots and related methods have been disclosed. This disclosure extends beyond the specifically disclosed examples to other alternative examples and/or other uses of the examples, as well as to certain modifications and equivalents thereof. Moreover, this disclosure expressly contemplates that various features and aspects of the disclosed examples can be combined with, or substituted for, one another. Accordingly, the scope of this disclosure should not be limited by the particular disclosed examples described above, but should be determined only by a fair reading of the claims. In some embodiments, the drive systems and/or support systems disclosed herein can be used to move other devices or systems different than a mobile robot.

1. (canceled)

2. (canceled)

3. (canceled)

4. (canceled)

5. (canceled)

6. A charger for charging a mobile robot, the charger comprising:
a first charger electrical contact that is configured to be in electrical connection with a first robot electrical contact when the mobile robot engages the charger;
a second charger electrical contact that is configured to be in electrical connection with a second robot electrical contact when the mobile robot engages the charger;
a shroud that is movable between a closed position and an open position, wherein the shroud is configured to cover the first and second charger electrical contacts in the closed position, wherein the shroud is configured to expose the first and second charger electrical contacts in the open position, and wherein the shroud is configured to be moved from the closed position to the open position when the mobile robot engages the charger;
a biasing structure for biasing the shroud toward the closed position;
a momentary switch movable between an off position and an on position, wherein the momentary switch is biased toward the off position, and wherein the momentary switch is configured to be moved from the off position to the on position when the mobile robot engages the charger;
one or more electromagnetic switches having an on configuration and an off configuration, wherein the one or more electromagnetic switches are configured to be turned to the on configuration by one or more magnets on the mobile robot when the mobile robot engages the charger;
wherein the charger is configured to:
enable charging through the first and second charger electrical contacts when both the momentary switch is in the on position, and the one or more electromagnetic switches are in the on configuration; and
disable charging through the first and second charger electrical contacts when either the momentary switch is in the off position, or the one or more electromagnetic switches are in an off configuration.

7. The charger of claim 6, comprising a controller configured to perform a handshake procedure to verify the mobile robot before charging is enabled.

8. The charger of claim 6, comprising a temperature sensor configured to measure a temperature of the charger, wherein the charger is configured to disable charging if the measured temperature of the charger is above a threshold.

9. The charger of claim 6, comprising an elevated protrusion that extends generally horizontally, wherein the first charger electrical contact is on an upper side of the protrusion, and wherein the second charger electrical contact is on a lower side of the protrusion.

10. The charger of claim 6, wherein the shroud is configured to move the momentary switch to the on position.

11. The charger of claim 6, wherein the momentary switch is positioned so that the mobile robot contacts the momentary switch to move the momentary switch to the on position.

12. (canceled)

13. (canceled)

14. The charger of claim 6, wherein the shroud comprises:
an upper portion that pivots upward to expose the first charger electrical contact on an upper side of a protrusion; and
a lower portion that pivots downward to expose the second charger electrical contact on a lower side of the protrusion.

15. The charger of claim 6, wherein the shroud comprises a brush that is configured to brush one or both of the first and second charger electrical contacts as the shroud moves.

16. The charger of claim 6, wherein the one or more electromagnetic switches comprise:
a first set of multiple electromagnetic switches arranged in series; and
a second set of multiple electromagnetic switches arranged in series, wherein the first and second sets of multiple electromagnetic switches are arranged in parallel.

17. (canceled)

18. A charging interface comprising:
one or more electrical contacts; and
a shroud that is movable between a closed position and an open position, wherein the shroud is configured to cover the one or more electrical contacts in the closed position, wherein the shroud is configured to expose the one or more electrical contacts in the open position.

19. The charging interface of claim 18, wherein the shroud is biased toward the closed position.

20. (canceled)

21. The charging interface of claim 18, wherein the shroud comprises a brush that is configured to brush the one or more electrical contacts as the shroud moves.

22. The charging interface of claim 18, comprising a momentary switch that is movable between an off position and an on position, biased toward the off position, and configured to disable charging when the switch is in the off position.

23. The charging interface of claim 18, comprising one or more electromagnetic switches configured to turn on in response to a magnetic field above a closing threshold and to turn off in response to a magnetic field below an opening threshold, and configured to disable charging when the one or more electromagnetic switches are in an off configuration.

24. The charging interface of claim 18, comprising a temperature sensor configured to measure a temperature of the charging interface, and configured to disable charging when the measured temperature of the charging interface is above a threshold.

25. The charging interface of claim 18, configured to perform a handshake procedure before charging is enabled.

26. The charging interface of claim 18, comprising an elevated protrusion that extends generally horizontally, wherein the one or more electrical contacts are on the protrusion.

27. A charging interface for charging a mobile robot, the interface comprising:
first and second electrical contacts;
a shroud biased toward a closed position, the shroud configured to expose the first and second electrical contact in an open position and to at least partially cover the first and second electrical contacts in the closed position;
a momentary switch actuatable by the shroud or the mobile robot, the momentary switch biased toward an off position and configured to impede a flow of electricity through the charging interface while in the off position; and
one or more electromagnetic switches configured to magnetically engage with one or more magnets associated with the mobile robot, wherein the one or more electromagnetic switches have a default off configuration to impede the flow of electricity through the charging interface, and wherein the one or more electromagnetic switches are configured to switch to an on configuration in response to magnetic engagement with the one or more magnets.

28. The charging interface of claim 27, comprising a controller configured to detect an electrical signal from the mobile robot, wherein, in response to detection of the electrical signal, the controller is configured to enable the flow of electricity through the charging interface for charging the mobile robot.

29. The charging interface of claim 27, comprising a temperature sensor configured to make a determination that a temperature of a portion of the charging interface is above a threshold temperature and, based on the determination, impede the flow of electricity through the charging interface.

30. (canceled)

31. (canceled)

32. (canceled)

33. (canceled)
